(19) United States
(12) Patent Application Publication
(10) Pub. No.: US 2026/0357921 A1
(43) Pub. Date: Nov. 12, 2026

(54) Low Noise and Anti-Cavitation Seat and Trim in Rotary Control Valve

(71) Applicant: Bray International, Inc., Houston, TX (US)

(72) Inventors: Sarath Ks, Bengaluru (IN); Mathew Varghese, Bengaluru (IN); Prasad Kumar, Bengaluru (IN); Pramod B. Kumar, Bengaluru (IN)

(21) Appl. No.: 19/747,546

(22) Filed: Jul. 20, 2026

Related U.S. Application Data
(63) Continuation-in-part of application No. 19/028,010, filed on Jan. 17, 2025, now Pat. No. 12,710,112.
(60) Provisional application No. 63/624,627, filed on Jan. 24, 2024.

(51) Int. Cl. F16K 47/04; F16K 5/06

(52) U.S. Cl. CPC F16K 47/045; F16K 5/0605

(57) ABSTRACT

A valve seat for a rotary control valve is provided, including a valve seat body having a generally cylindrical shape defining a bore and a shoulder formed on an exterior surface of the valve seat. The valve seat body houses a first circular curved plate and a second circular curved plate positioned next to the first circular curved plate. The first circular curved plate defines a first set of openings, and the second circular curved plate defines a second set of openings. The first and second sets of openings are arranged such that they are unaligned with one another, thereby reducing cavitation and noise of the rotary control valve via the valve seat.

### BACKGROUND

Technical field: Segmented ball valves are designed for the precise control of gas, steam, liquids, and fibrous slurries. A common challenge encountered in control valves involves cavitation and noise during the pressure reduction from upstream to downstream conditions as required by the process requirements. Conventional prior segmented ball valves incorporate specialized features to mitigate cavitation and noise during their operation by using special trims welded to the segment.

Segmented ball valves are commonly used control valves for various liquids and gases which generates high noise in the process. Noise is reduced by introducing noise attenuators on the segment which distributes the pressure drop into multiple stages and absorbs energy thereby reducing the noise. The valve is operated by positioning the segment at the required opening to attain a particular process condition. The noise attenuator on the segment provides maximum restriction at lower openings working at high pressure drops and least restriction at higher openings working at low pressure drops.

Cavitation is a liquid phenomenon of formation of vapor bubbles where the pressure of the liquid falls below its vapor pressure and collapsing of these bubbles in the higher-pressure region. Cavitation too often produces high level noise and vibration.

Conventional segmented ball valves are characterized by a single-piece body construction. During assembly, the segment which is larger than the body bore requires precise alignment for insertion through the segment entry bore of the body. Once inside, the segment must be rotated within the spherical cavity of the body to achieve the correct position. The inclusion of anti-cavitation or noise trim, or noise attenuators, welded onto the segment, adds to its overall size, presenting challenges during assembly into the body. This limitation impacts the number and size of plates that can be incorporated into the cavitation or noise trim, resulting in suboptimal trim or attenuator performance. Moreover, any modifications to the cavitation or noise trim or attenuator design on-site due to changes in process conditions would mandate the replacement of the entire segment, necessitating a repetition of the hydro seat test.

Conventional or typical anti-cavitation and noise trims or attenuators in rotary ball valves often employ straight plates that are welded onto the segment. However, these conventional trims and attenuators lack the ability to generate an expanding flow or non-impinging jet streams in its flow profile. Ideally, anti-cavitation trims should be able to generate cyclic flow expansion and flow contraction; however, many conventional trims fail to do so. Consequently, the performance of such trim or attenuator configurations is suboptimal in preventing cavitation and high noise.

Segmented ball valves are needed for many applications due to its specific features. The industry requires a solution that effectively mitigates or eliminates cavitation and noise. Accordingly, there is a need for a segmented ball valve which can optimize the efficient reduction of cavitation and noise, generate cyclic flow expansion and flow contraction, and offer the convenience of on-site replacement of cavitation and noise-reducing components with minimal effort.

### BRIEF SUMMARY

Exemplary embodiments disclosed herein relate to various features in the segmented ball valves to reduce noise and cavitation more efficiently, generate cyclic flow expansion and flow contraction, and provide the flexibility to replace the noise reducing features within the valve at site with minimum effort.

Usage of the terms “linkages”, “links”, “elements”, “connectors” or “bars” herein may also encompass “plates” or “rods” for the exemplary embodiments described in FIGS. 1-25, having any cross section shapes which are regular polygonal, irregular polygonal, circular, or ovoid, and which link or connect a first end of the interior surface of a low noise and anti-cavitation cartridge to a second end of the interior surface of the low noise and anti-cavitation cartridge.

The disclosure relates to a valve seat for a rotary control valve having a valve seat body of the valve seat, wherein the valve seat body has a cylindrical shape defining a bore; a shoulder defined on an exterior surface of the valve seat; and/or a first circular curved plate within the valve seat body; and/or a second circular curved plate within the valve seat body, positioned next to the first circular curved plate; and/or wherein the first circular curved plate defines a first set of openings within the first circular curved plate; and/or wherein the second circular curved plate defines a second set of openings within the second circular curved plate; and/or where in the first set of openings and the second set of openings are unaligned; and/or wherein the first circular curved plate defines a first circular curved plate concave surface and a first circular curved plate convex surface; and/or wherein the second circular curved plate is positioned downstream of the first circular curved plate and wherein the first circular curved concave surface is upstream of the first circular curved plate convex surface; and/or the first circular curved plate and the second circular curved plate are each orthogonal to a flow of the rotary control valve; and/or wherein the flow passes into and through the first circular curved plate and then the second circular curved plate; and/or wherein each of the first set of openings and the second set of openings are hexagonal-shaped openings of the same size; and/or wherein the valve seat defines a seating surface adjacent to the first circular curved plate concave surface configured to seal against a control element of the rotary control valve; and/or further comprising a first gap between the first circular curved plate and the second circular curved plate; and further comprising a second gap between the first circular curved plate concave surface and the control element.

The disclosure further relates to a cartridge for reducing noise and cavitation within a segmented ball of a rotary control valve, having a first curved plate within the cartridge; and/or a second curved plate within the cartridge, wherein the second curved plate is adjacent to the first curved plate; and/or a first plurality of apertures defined on the first curved plate; and/or a second plurality of apertures defined on the second curved plate, wherein the second plurality of apertures are unaligned with the first plurality of apertures; and/or wherein the first curved plate and the second curved plate each have a circular perimeter; and/or the first curved plate and the second curved plate are each orthogonal to a flow direction of the rotary control valve in a fully open position of the rotary control valve; and/or wherein the flow direction passes into and through the first curved plate and then the second curved plate; and/or wherein the cartridge defines a cylindrical shape and further comprising a first tab extending from the cylindrical shape at a top of the cartridge and a second tab extending from the cylindrical shape at a bottom of the cartridge; and/or wherein each of the first tab and the second tab define a stem opening.

The disclosure also relates to a method for obtaining a gradual pressure drop in a rotary control valve, having the steps of inserting a valve seat into a closely fitting port defined within the rotary control valve; and/or wherein the valve seat comprises a first circular curved plate and a second circular curved plate orthogonal to a flow direction of the rotary control valve in a fully opened position; and/or wherein the first circular curved plate defines a first set of apertures, and the second circular curved plate defines a second set of apertures; and/or wherein the first set of apertures is offset from the second set of apertures; and/or inducing a pressure dropping stage between the first circular curved plate and the second circular curved plate; and/or further expanding a fluid flow and contracting the fluid flow within the pressure dropping stage; and/or preventing a pressure of the fluid flow from dropping below a vapor pressure of the fluid flow; and/or contracting the fluid flow between the first circular curved plate and the second circular curved plate; and/or expanding the fluid flow between the first circular curved plate and the second circular curved plate.

The disclosure further relates to a method for obtaining a gradual pressure drop in a rotary control valve, having the steps of providing a segmented ball; and/or inserting a cartridge into a closely fitting internal cavity defined within the segmented ball; and/or wherein the cartridge comprises a first circular curved plate and a second circular curved plate orthogonal to a flow direction of the rotary control valve in a fully opened position; and/or wherein the first circular curved plate defines a first set of apertures, and the second circular curved plate defines a second set of apertures; wherein the first set of apertures is offset from the second set of apertures; and/or inducing a pressure dropping stage between the first circular curved plate and the second circular curved plate; and/or expanding a fluid flow and contracting the fluid flow within the pressure dropping stage; and/or preventing a pressure of the fluid flow from dropping below a vapor pressure of the fluid flow; and/or contracting the fluid flow between the first circular curved plate and the second circular curved plate; and/or expanding the fluid flow between the first circular curved plate and the second circular curved plate; and/or replacing the cartridge without replacing the segmented ball.

### BRIEF DESCRIPTION OF THE DRAWINGS

The embodiments may be better understood, and numerous objects, features, and advantages made apparent to those skilled in the art by referencing the accompanying drawings. These drawings are used to illustrate only typical embodiments of this disclosure, and are not to be considered limiting of its scope, for the disclosure may admit to other equally effective embodiments. The figures are not necessarily to scale and certain features and certain views of the figures may be shown exaggerated in scale or in schematic in the interest of clarity and conciseness.

FIG. 1 depicts a perspective view partially in cross section of a segmented rotary control valve shown in an exemplary embodiment during assembly, disassembly, or replacement of an exemplary embodiment of a cartridge for anti-cavitation and low noise.

FIG. 2 depicts an end view of a segmented rotary control valve shown in one modulating position in an exemplary embodiment.

FIG. 3 depicts a top view of the cross section of an exemplary embodiment of a segmented rotary control valve with an exemplary embodiment of a cartridge for anti-cavitation and low noise shown in one modulating or partially opened position.

FIG. 4 depicts a top view of the cross section of an exemplary embodiment of a segmented rotary control valve with an exemplary embodiment of a cartridge for anti-cavitation and low noise shown in a fully opened position.

FIG. 5 depicts a perspective view of the cross section of the exemplary embodiments of the segmented rotary control valve and cartridge for anti-cavitation and low noise as shown in FIG. 4.

FIG. 6 depicts an enlarged view of the cross section of the linkages or plates of an exemplary embodiment of the cartridge for anti-cavitation and low noise and an exemplary embodiment of a jet stream flowing through the linkages.

FIG. 7 depicts an enlarged view of the cross section of the linkages or plates of an exemplary embodiment of the cartridge for anti-cavitation and low noise and an exemplary embodiment of a jet stream flowing through the linkages.

FIG. 8 depicts an enlarged view of the cross section of the linkages or plates of an alternative exemplary embodiment of the cartridge for anti-cavitation and low noise and an alternative exemplary embodiment of a jet stream flowing through the linkages.

FIG. 9 depicts a top view of the cross section of an exemplary embodiment of a segmented rotary control valve with an alternative exemplary embodiment of a cartridge for anti-cavitation and low noise shown in a fully opened position.

FIG. 10 depicts a perspective view of the cross section of the segmented rotary control valve and the alternative exemplary embodiment of the cartridge for anti-cavitation and low noise as shown in FIG. 9.

FIG. 11 depicts a top view of the cross section of an exemplary embodiment of a segmented rotary control valve with an alternative exemplary embodiment of a cartridge for anti-cavitation and low noise shown in a fully opened position.

FIG. 12 depicts a perspective view of the cross section of the segmented rotary control valve and the alternative exemplary embodiment of the cartridge for anti-cavitation and low noise as shown in FIG. 11.

FIG. 13 depicts a top view of the cross section of an exemplary embodiment of a segmented rotary control valve with an alternative exemplary embodiment of a cartridge for anti-cavitation and low noise shown in a fully opened position.

FIG. 14 depicts an enlarged top view of the cross section of the exemplary embodiment of a segmented rotary control valve with the alternative exemplary embodiment of a cartridge for anti-cavitation and low noise as shown in FIG. 13.

FIG. 15 depicts a top perspective view of a top cross section of an exemplary embodiment of a segmented rotary control valve with an alternative exemplary embodiment of a cartridge for anti-cavitation and low noise shown in a fully opened position.

FIG. 16 depicts a front perspective view of a side cross section of the exemplary embodiment of a segmented rotary control valve with the alternative exemplary embodiment of a cartridge for anti-cavitation and low noise as shown in FIG. 15.

FIG. 17 depicts a different top perspective view of a top cross section of the exemplary embodiment of the segmented rotary control valve with the alternative exemplary embodiment of the cartridge for anti-cavitation and low noise as shown in FIGS. 15-16.

FIG. 18 depicts a top view of the cross section of an exemplary embodiment of a segmented rotary control valve with an alternative exemplary embodiment of a cartridge for anti-cavitation and low noise shown in a fully opened position.

FIG. 19 depicts a perspective view of the cross section of the segmented rotary control valve and the alternative exemplary embodiment of the cartridge for anti-cavitation and low noise as shown in FIG. 18.

FIG. 20 depicts an enlarged view of the top cross section of the linkages or rods of the exemplary embodiment of the cartridge for anti-cavitation and low noise as shown in FIGS. 18-19.

FIG. 21 depicts a top view of the cross section of an exemplary embodiment of a segmented rotary control valve with an alternative exemplary embodiment of a cartridge for anti-cavitation and low noise shown in a fully opened position.

FIG. 22 depicts a perspective view of the cross section of the segmented rotary control valve and the alternative exemplary embodiment of the cartridge for anti-cavitation and low noise as shown in FIG. 20.

FIG. 23 depicts a perspective view of the alternative exemplary embodiment of the cartridge for anti-cavitation and low noise as shown in FIGS. 20-21, having a partial cross section cut-out of the cartridge.

FIG. 24 depicts a graph comparing the pressure of an exemplary fluid flow in a segmented rotary control valve with an exemplary embodiment of a cartridge trim for anti-cavitation and low noise, and a fluid flow for a conventional or commercially available segmented rotary control valve.

FIG. 25 depicts a top view of the cross section of an alternative exemplary embodiment of a segmented rotary control valve with an exemplary embodiment of a cartridge for anti-cavitation and low noise shown in one modulating or partially opened position in a shaft upstream direction with an exemplary embodiment of a hardened liner.

FIG. 26 depicts a side cross section view of a segmented rotary control valve with an exemplary embodiment of an improved seat for anti-cavitation and low noise.

FIG. 27 depicts a perspective view partially in side cross section of a segmented rotary control valve shown in an exemplary embodiment during assembly, disassembly, or replacement of an exemplary embodiment of an improved seat for anti-cavitation and low noise.

FIG. 28 depicts a perspective view with side cross section of a segmented rotary control valve with an exemplary embodiment of an improved seat for anti-cavitation and low noise.

FIG. 29 depicts an end view of an outlet end of the segmented rotary control valve with an exemplary embodiment of an improved seat for anti-cavitation and low noise.

FIG. 30 depicts an end view of an inlet end of the segmented rotary control valve with an exemplary embodiment of an improved seat for anti-cavitation and low noise, wherein the segmented rotary control valve is in a fully open position.

FIG. 31 depicts an end view of an inlet end of the segmented rotary control valve with an exemplary embodiment of an improved seat for anti-cavitation and low noise, wherein the segmented rotary control valve is in a partially open or modulating position.

FIG. 32 depicts an end view of an inlet end of the segmented rotary control valve with an exemplary embodiment of an improved seat for anti-cavitation and low noise, wherein the segmented rotary control valve is in a partially open or modulating position.

FIG. 33 depicts a perspective view with bottom cross section of a segmented rotary control valve with an exemplary embodiment of an improved seat for anti-cavitation and low noise.

FIG. 34 depicts a front view of an exemplary embodiment of a pattern of openings defined in an exemplary embodiment of a curved plate for an improved seat for anti-cavitation and low noise.

FIG. 35 depicts a front view of an exemplary embodiment of two or more curved plates as assembled for an improved seat for anti-cavitation and low noise.

FIG. 36 depicts a perspective view of an exemplary embodiment of an improved seat for anti-cavitation and low noise.

FIG. 37 depicts a side cross section view of an exemplary embodiment of an improved seat for anti-cavitation and low noise.

FIG. 38 depicts a perspective view with side cross section of an exemplary embodiment of an improved seat for anti-cavitation and low noise.

FIG. 39 depicts a perspective view with side cross section of a segmented rotary control valve with an exemplary embodiment of a cartridge for anti-cavitation and low noise, wherein the valve is in the closed position.

FIG. 40 depicts a perspective view of the cross section of the top view of an exemplary embodiment of the segmented rotary control valve and cartridge for anti-cavitation and low noise.

FIG. 41 depicts a partial cross section of an end view of an exemplary embodiment of the segmented rotary control valve, wherein an exemplary embodiment of the cartridge for anti-cavitation and low noise is shown without cross section.

FIG. 42 depicts a perspective view partially in side cross section of a segmented rotary control valve shown in an exemplary embodiment during assembly, disassembly, or replacement of an exemplary embodiment of a cartridge for anti-cavitation and low noise.

FIG. 43 depicts a top cross section view of an exemplary embodiment of the cartridge for anti-cavitation and low noise.

FIG. 44 depicts a top cross section view of an alternative exemplary embodiment of the cartridge for anti-cavitation and low noise.

FIG. 45 depicts a perspective view of an alternative exemplary embodiment of the cartridge for anti-cavitation and low noise.

### DETAILED DESCRIPTION OF THE EMBODIMENT(S) SHOWN

The description that follows includes exemplary apparatus, methods, techniques, and instruction sequences that embody techniques of the inventive subject matter. However, it is understood that the described embodiments may be practiced without these specific details.

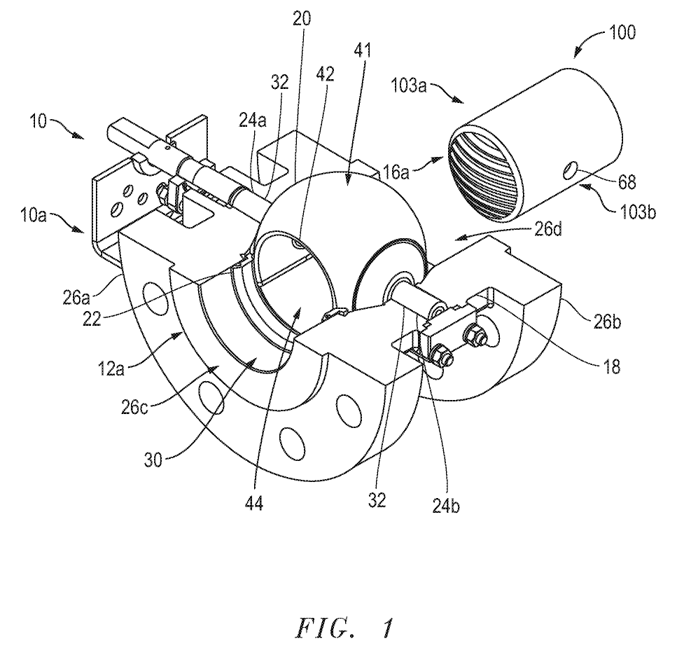

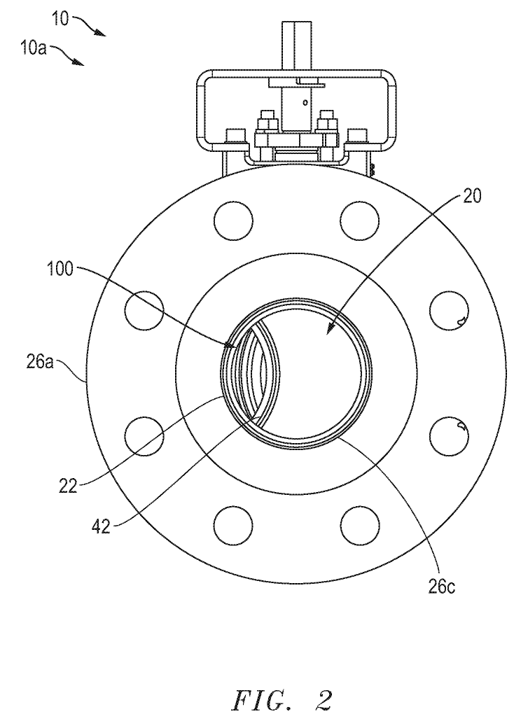

FIG. 1 depicts a perspective view partially in cross section of a segmented rotary control valve 10 shown in the exemplary embodiment of a segmented ball valve 10a. The valve 10 or 10a is shown in an exemplary embodiment during assembly, disassembly, or replacement of an exemplary embodiment of a cartridge 100 for anti-cavitation and low noise. FIG. 2 depicts a front view of a segmented rotary control valve 10 shown in one modulating position in an exemplary embodiment. The modulating position is a partially open position of the rotary control valve 10 which allows an upstream flow path 12a through the segmented valve 10a through to the downstream flow path 16a. In the presently described embodiments, the rotary control valve 10 and segmented valve 10a is a unidirectional valve having an upstream flow path 12a and a downstream flow path 16a through the cartridge 100. It is to be noted that the segmented rotary control valve 10, is not usually fully closed and neither is it usually fully open wherein the direction of flow is one direction. Rather the segmented rotary control valve 10 is normally modulating between a variety of positions there-between a fully closed position and a fully open position.

The segmented rotary control valve 10 may have a valve body 18, a segmented ball 20, a valve seat 22, upper valve stem 24a and lower valve stem 24b, and two connector ends 26a, 26b. Connector end 26a defines a relatively smaller diameter opening 26c to the valve body 18, and consequently flow path 30, relative to connector end 26b which defines a relatively larger diameter opening 26d to the valve body 18 and consequently flow path 30.

In the closed position, the segmented ball 20 is rotated thereby sealing the upstream flow path(s) 12a with a solid portion of the segmented ball 20 against the valve seat 22. In the open position, achieved via rotation of the segmented ball 20, an aperture 30 defined by the valve body 18 allows fluids to flow through the segmented ball valve 10a via the upstream flow path(s) 12a. The upper valve stem 24a and lower valve stem 24b may penetrate the valve body 18 through an access way 32 in the valve body 18. An actuator (not shown) may couple to the upper valve stem 24a in order to actuate the segment ball 20 between a variety of open positions and the closed position. The connector ends 26 as shown are configured for connection to piping (not shown). The connector ends 26 may be any suitable connection including, but not limited to, welding, butt welds, socket welds, bolt on flanges, and the like.

The segmented ball 20 includes a front side or profile 41 that is facing or opposing the upstream flow path 12a when the segmented ball 20 is in the closed position. The segmented ball 20 defines an internal hollow, chamber, or cavity such as a precision machined cylindrical bore 42 on the back side 44 of the segmented ball 20. The internal cavity 42 is adapted for receiving or to fit-in a replaceable low noise and anti-cavitation cartridge 100 within the segmented ball 20. The cavity 42 passes entirely through the segmented ball 20.

Referring to the exemplary embodiments of FIG. 1 the segmented rotary control valve 10 is assembled or disassembled with the upper stem 24a and the lower stem 24b pushed or pulled through the segmented rotary control valve 10 and the segmented ball 20, and wholly pushed or pulled out of the cartridge 100 to enable respective assembly, disassembly, and replaceability of cartridge 100 (by contrast in the prior art there is a great deal of difficulty, due to interference, of assembling a fully welded/integrated type noise attenuator into a valve without a cartridge 100). It is to be noted that the upper stem 24a and the lower stem 24b will remain in the segmented ball 20 during the assembly or disassembly of the cartridge 100, and hence the segmented ball 20 shall remain in place within the segmented rotary control valve 10 during the assembly, disassembly, and/or replacement of the cartridge 100. The upper and lower stems 24a, 24b may be pulled out slightly to facilitate the assembly of the cartridge 100 into the valve 10. The cartridge 100 of FIG. 1 is inserted through the valve 10 downstream bore 26d into the closely fitting internal passage or cylindrical bore 42 of the segmented ball 20 kept in the fully open position. In one exemplary embodiment the close fit may be defined as a H7/g6 clearance or fit. The cartridge 100 may be locked within the segmented ball 20 as follows: the upper stem 24a and the lower stem 24b are then inserted into the final position via slots 64 and 68 through the cartridge body 62 to firmly secure and/or anchor the cartridge 100 in place through and within the segmented ball 20 and the valve body 18. The upper stem 24a and the lower stem 24b do not pass through the cartridge 100 but each preferably terminates at one end within the wall of the cartridge body 105. The downstream opening of the valve body 18, as adjacent to the segmented ball 20, may optionally include a liner (not shown) for protecting the valve body 18. The liner may act as a protection for residual cavitation, if any.

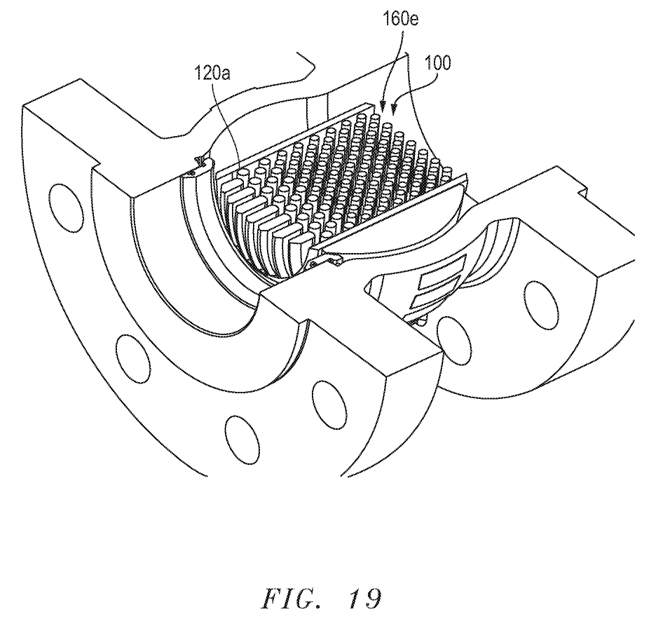

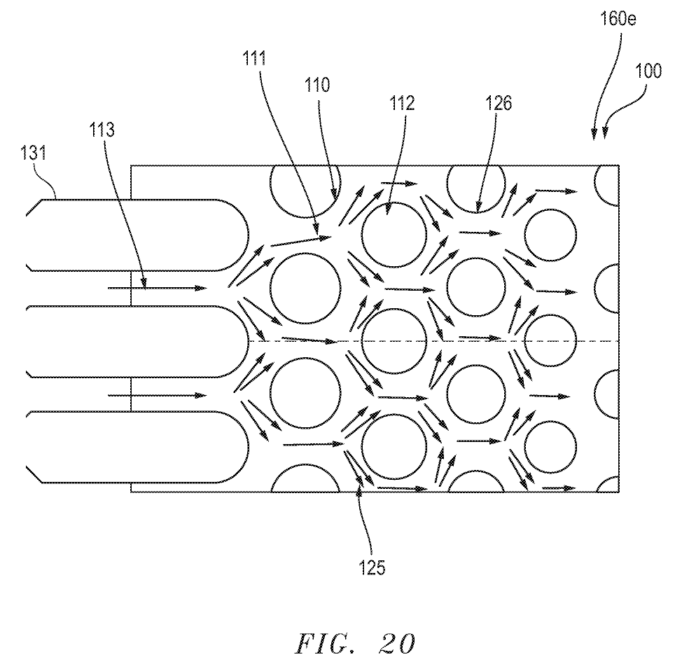

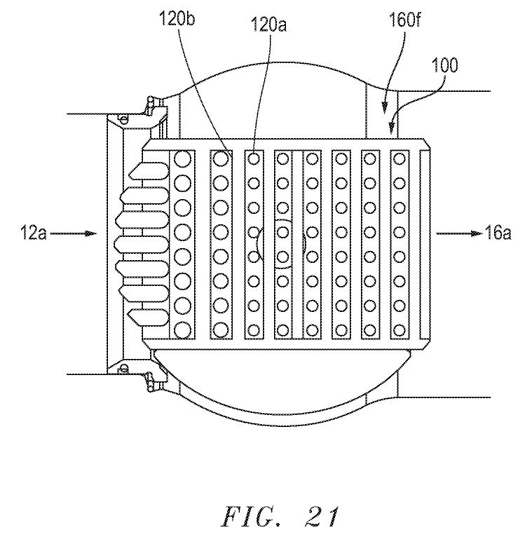

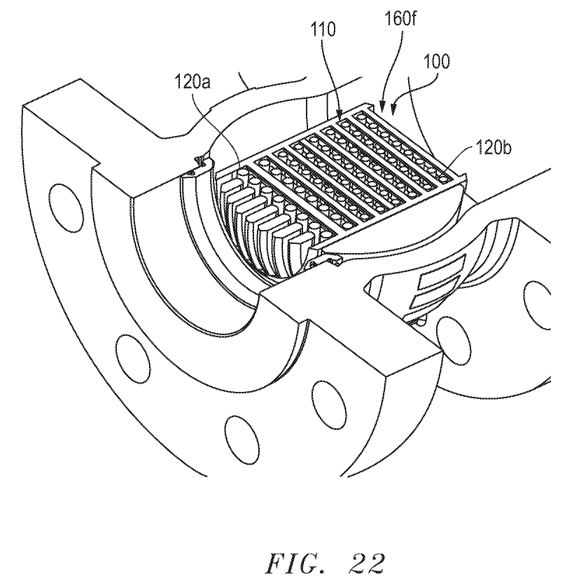

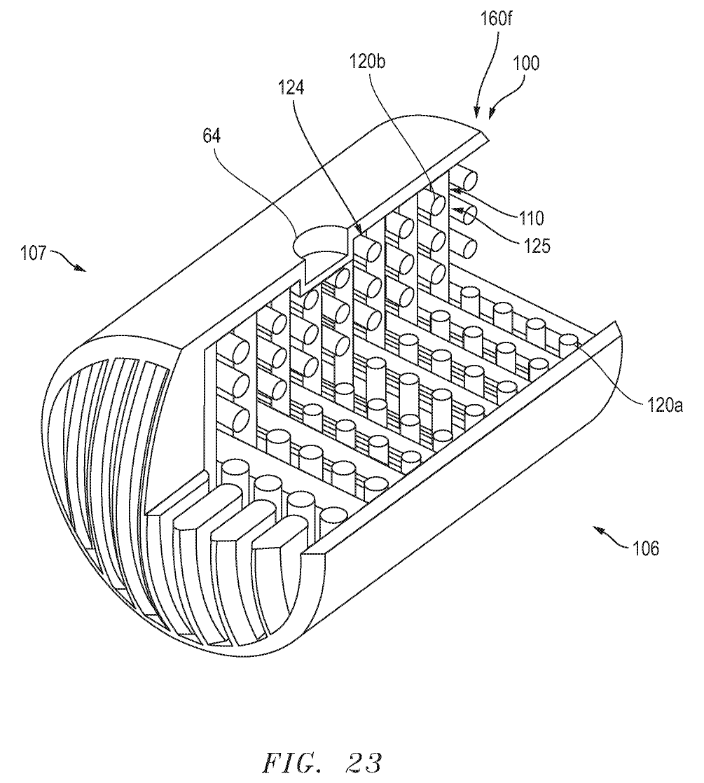

The segmented ball valve 10a specifically engineered for anti-cavitation and noise reduction purpose uses a replaceable and removable cartridge 100 which is securely positioned within the segmented ball 20, and held in place by the stem 24a and end post 24b. The cartridge 100 incorporates linkages or bars 120, which may be irregular or regular polygonal-shaped plates 130 or a combination of polygonal shaped plates 130 and round bars or rods 140 (see rods 140 in, e.g. FIGS. 18-22) facilitating staged pressure reduction and effectively mitigating or eliminating the occurrence of high-intensity cavitation and noise. The segmented ball 20 has a precisely machined cylindrical bore 42 designed to accommodate a slide-fit anti-cavitation and noise reduction cartridge 100; this allows for convenient field replaceability of the cartridge 100 with minimal effort and eliminates the need for any welding or fasteners to affix the cartridge 100 to the segmented ball 20. This cartridge 100 also facilitates the utilization of the fully cylindrical bore 42 inside the segmented ball 20 for incorporating a greater number of pressure reduction stages 110 compared to the currently available or conventional designs.

As mentioned before, unlike the conventional cavitation and noise reduction trims, in the present embodiments, a cartridge 100 trim is introduced onto the segmented ball 20 without the help of welding or fasteners. This cartridge 100 trim can split the pressure drop across multiple pressure reduction stages 110 and absorb kinetic energy ensuring the pressure at any stage 110 will not drop below the vapor pressure of the fluid, which is a key factor in cavitation. The cartridge 100 is intended to be used for a unidirectional flow path from upstream 12a to downstream 16a, and can be modulated or used in any number of partially open positions (see, e.g., FIG. 2) between the fully opened and fully closed positions.

Conventional segmented ball valves can exhibit notably low liquid pressure recovery factor (hereinafter, also referred to as “FL”) values, which leads to the occurrence of cavitation even in low pressure drop applications. However, the incorporation of anti-cavitation cartridge 100 trim has the potential to elevate the FL value closer to 1. Thus the cartridge 100 is enabled to handle high-pressure drops without having cavitation issues. Additionally, an increase in the number of flow paths results in a reduction in valve style modifier, or F_{d}, values, leading to decreased noise levels. Effective mitigation or elimination of cavitation and noise of the present exemplary embodiments of cartridges 100 can be achieved by incorporating a higher number of pressure-reducing stages 110, thus intermixing of internal jet streams 113.

The segmented ball valve 10a or rotary control valve 10 utilizes a precisely machined cylindrical bore 42 of the segmented ball 20 to accommodate the interchangeable anti-cavitation and noise cartridge 100. The cartridge 100 consists of linkages, or bars 120, which may include irregular or regular polygonal-shaped plates 130 and/or rods 140, oriented perpendicular or orthogonal to the unidirectional flow direction from upstream flow path 12a to downstream flow path 16a. These linkages, or bars 120, including irregular or regular polygonal-shaped plates 130 and/or rods 140, effectively alter the flow direction from one stage 110 to another stage 110 and inducing pressure drops through expansion 112 and contraction 111 cycles.

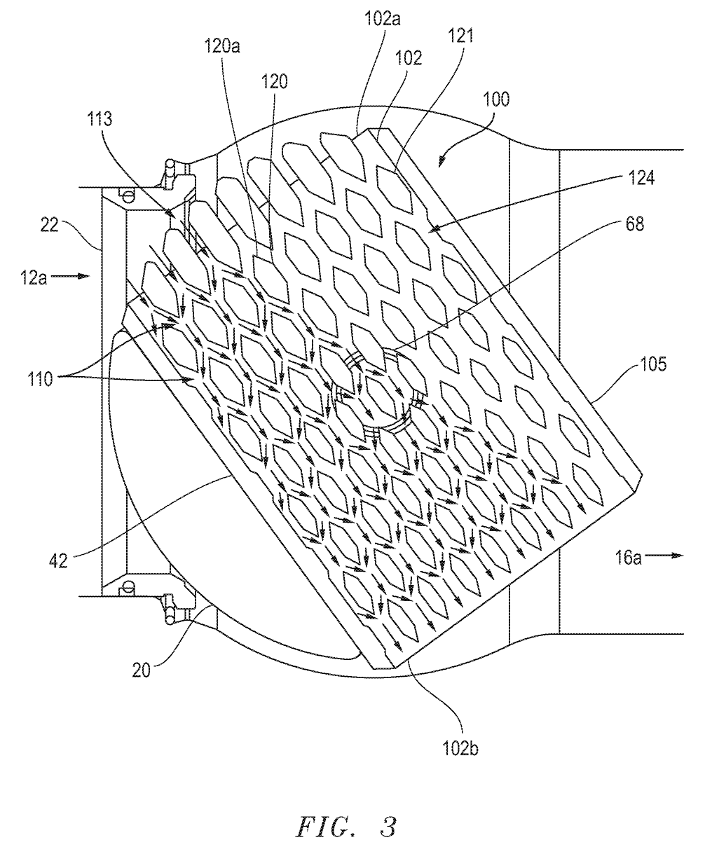

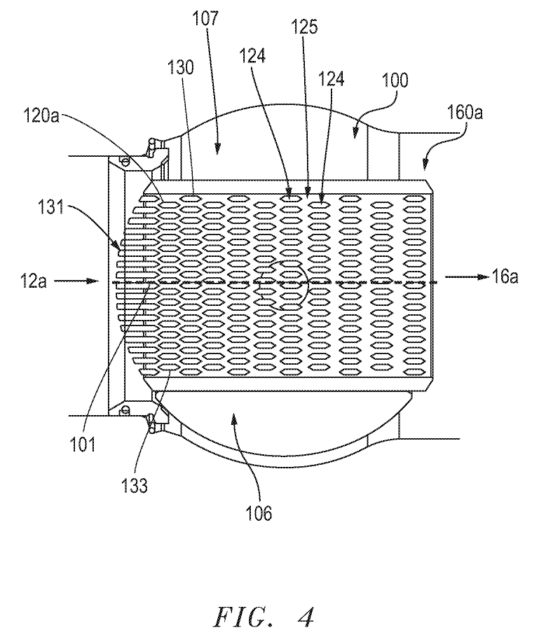

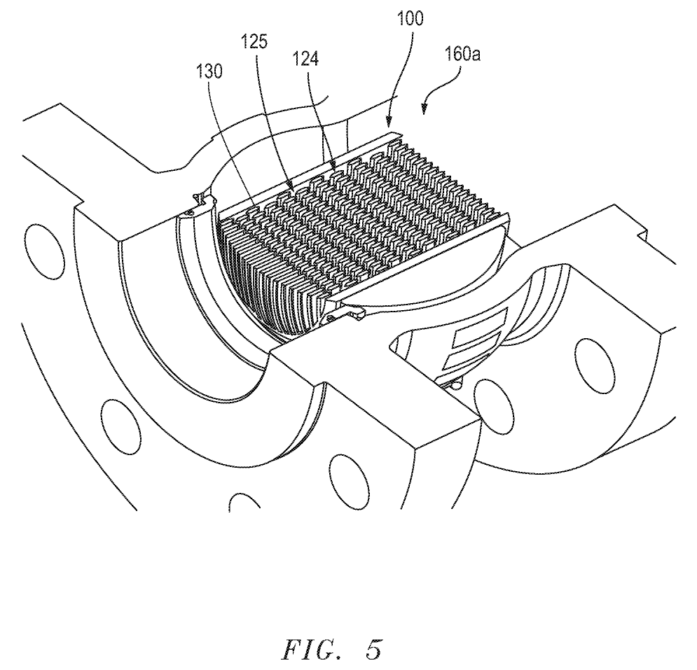

Referring further to FIGS. 3-4, which show the segmented rotary control valve 10 and cartridge 100 in a modulating or partially opened position, and a fully opened position, respectively, the low noise and anti-cavitation cartridge 100 has a substantially cylindrical or tubular body 105 about or along a longitudinal axis 101, configured to fit within the precision machined bore 42 of the segmented ball 20, wherein the cartridge 100 is configured to reduce and/or eliminate and/or mitigate noise and cavitation for a flow or jet stream 113. The FIG. 5 depicts the exemplary embodiment of the cartridge 100 of FIG. 4 in a fully opened position of the valve 10. The cartridge body 105 defines a substantially cylindrical, tubular, or pipe-like inner surface 102, and further defines a first or upstream edge, end, or opening 102a and a second or downstream edge, end or opening 102b. The cartridge body 105 further defines a top half semi-cylinder 103a, wherein the upper stem 24a may be inserted into the slot 64 of the cartridge 100, and a bottom half semi-cylinder 103b, wherein the bottom stem 24b may be inserted into slot 68 of the cartridge 100, (and as can be seen in FIG. 1 and partially in FIG. 3).

The linkages 120a are positioned orthogonal to the unidirectional flow direction from upstream 12a to downstream 16a when the valve 10 is in a fully open position (see, e.g. FIG. 4); the linkages 120a thus connect the top half semi-cylinder 103a of the cartridge body 105 at a first end of the linkage 120a, to the bottom half semi-cylinder 103b of the cartridge body 105 at a second end of the linkage 120a. These orthogonal linkages 120a are arranged in a number or multiple of rows or groups 124, wherein the first row 124 is towards an upstream end 102a of the cartridge 100, and the last row is towards the downstream end 102b of the cartridge 100. The first linkage 120a within each row 124 is at or towards a front 106 of the cartridge body 105, and the last linkage 120a of the row 124 is towards a rear 107 of the cartridge body 105; and further wherein the linkages 120a in each subsequent downstream row 124 are offset, unaligned, or non-parallel from the position of the linkages 120a in the prior, upstream row 124. By way of example only, the first of the linkages 120a in a downstream or subsequent row 124 may be shifted closer or farther away towards the front 106 than the first of the linkages 120a in a prior, upstream, or earlier row 124.

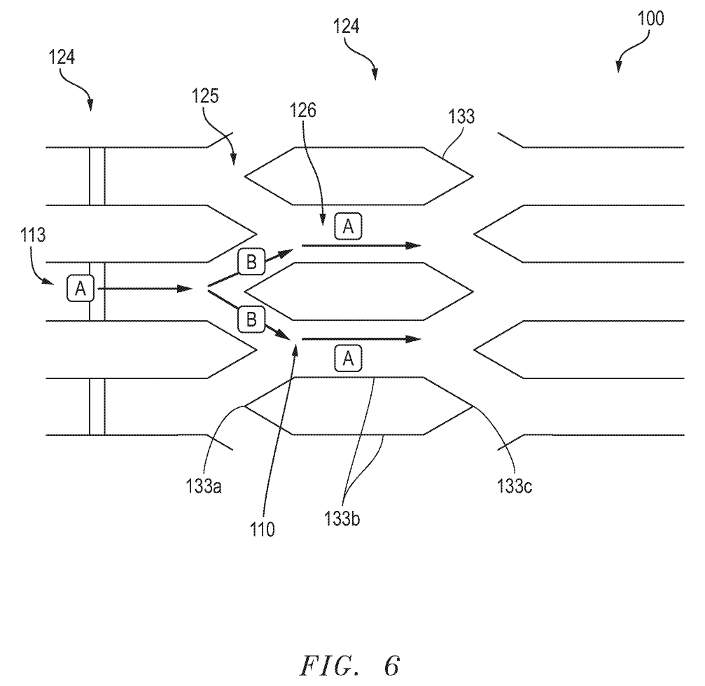

FIGS. 3-6 depict various cross section views of a cartridge 100, including an enlarged cross section view in FIG. 6, which shows the details of the linkages 120, in particular the plates 130 of the exemplary embodiment of the cartridge 100 or 160a. Each linkage 120, 120a or plate 130 or rod 140 has a cross section 121. In the exemplary embodiments of the cartridge 160a (and also cartridges 160b, 160c, and 160d of FIGS. 9-17) each plate 130 has a polygonal cross section 133 which includes a flow facing edge 133a, and a non-flow facing edge 133c. The flow facing edge 133a and non-flow facing edge 133c are connected by parallel faces 133b. Parallel faces 133b can be parallel to the longitudinal axis 101 of the trim 100 or the parallel faces 133b can be at an angle with respect to the longitudinal axis 101 of the trim 100. The flow facing edge 133a of the plate 130 may play a crucial role in inducing stream 113 bifurcation, as later described herein and the faces of the flow facing edge 133a may have a preferred angle in the range of 30 degrees to 120 degrees in certain exemplary embodiments. The cartridge 160a may also include straight entry linkages or plates 131 set or positioned at the upstream end 102a which guide the jet stream or flow 113 into the cartridge 160a interior. In an alternative exemplary embodiment, the cartridge 160a may also optionally, instead or further, include straight exit linkages or plates (not shown) set or positioned at the downstream end 102b which guide the jet stream or flow 113 out of the cartridge 160a.

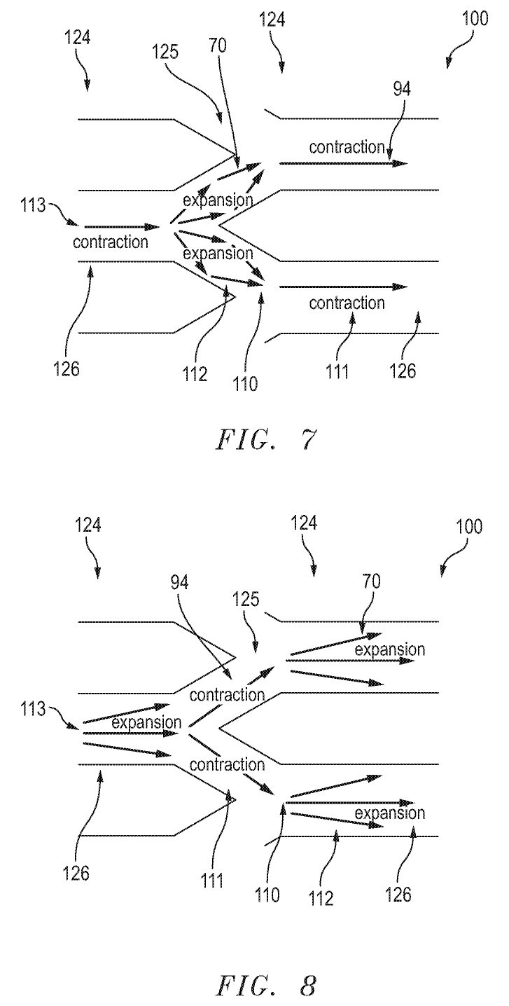

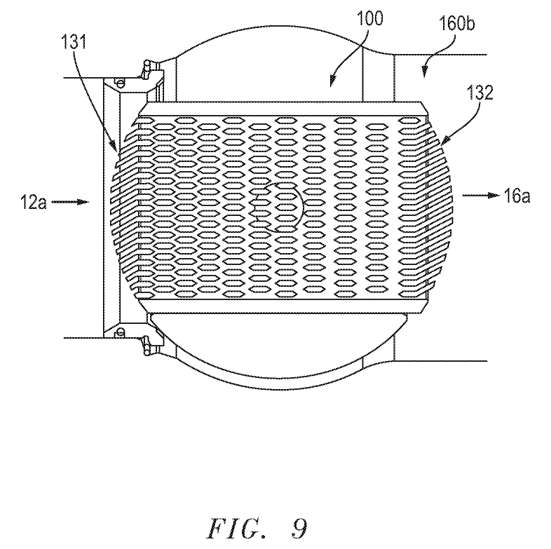

A number of areas 125 are defined between each row 124 of linkages 120, 120a, or plates 130, which allows the stream 113 to intermix and drop the pressure below cavitation pressure levels at the pressure dropping stage 110. Areas 126 are also defined between each linkage 120, 120a, or plate 130 in a row 124, and between the linkages 120, 120a or plates 130 and the interior surface 102 of the cartridge body 105. The interfaces or intermixing areas between the flow area 125 and flow area 126 are the pressure dropping stages 110. While the exemplary embodiments of the cartridges 160a as depicted in FIGS. 4-5, show ten (10) rows 124 of linkages 120, 120a or plates 130, thus having nine (9) pressure dropping stages 110, a greater or fewer number of rows 124 and pressure dropping stages 110 are encompassed within the present disclosure. Conventional or currently known segmented balls are unable to achieve the number of pressure dropping stages 110 as disclosed herein. The flow or stream 113 may enter into the cartridge 100 from the upstream end 102a into a first area 125, and then is bifurcated into a downstream area 126; each area 126 then flows into each subsequent or downstream area 125. Additionally, each subsequent or downstream area 125 may be increased in size or same in size compared to earlier, prior or upstream area 125. Likewise, each row 124 of areas 126 may be increased in size or same in size compared to earlier, prior or upstream areas 126. In other words, subsequent rows 124 of linkages 120 may be set an increasingly farther distance from earlier upstream rows 124 of linkages 120, and the area 126 between each linkage 120 may increase in each subsequent downstream row 124; thus each link 120, 120a or plate 130 (or rod 14) has greater flow areas 125, 126 around said link 120 the further downstream in the cartridge 100 that the link 120 is located. The increase in flow areas 125, 126 around each link 120 may be aided by a shrinking or decrease of the size or cross section area 121 of the link 120 itself the farther downstream of the cartridge 100 that the link 120 is situated when the flow area 125 is larger than the flow area 126 – this may be seen, by way of example, in at least FIG. 4. The exemplary embodiment of the cartridge 160a as depicted in and described for FIGS. 4-5may be the preferred exemplary embodiment. However, in alternative exemplary embodiments, such as shown in at least FIG. 8, when the flow area 125 is smaller than the flow area 126, the cross section 121 size of linkages 120 (or plates 130 or rods 14) are same or identical across all the plurality of rows 124.

The exemplary embodiments of the cartridges 100, 160a-160f disclosed herein optimize and adjust the flow coefficient, or Cᵥ, via at least, adjusting the number of pressure dropping stages 110, which is one of several variables related to the flow coefficient Cᵥ. By way of example only, as the number of pressure dropping stages 110 increase, the flow coefficient Cᵥ is expected to decrease; conversely, as the number of pressure dropping stages 110 decrease, the flow coefficient Cᵥ is expected to increase. The area or spacing 125 between the rows 124 and the stages 110 is another variable which can be adjusted in the disclosed cartridges 100 that can affect the flow coefficient Cᵥ.

Referring to FIG. 6, the initial flow or jet stream 113, upon entering the upstream end 102a, traverses a singular channel [A] before bifurcating into two distinct paths [B]. Cycles of expansion 112 and contraction 111 can be induced through two different processes and alternative exemplary embodiments as depicted in and described for FIGS. 7 and 8. In FIG. 7, the area between the rows 125, has a larger flow area [B] than the area 126 between adjacent linkages 120 within rows 124, which has a narrower flow area [A]. In comparison, in FIG. 8, the area 125 between the rows 124, has a smaller or narrower flow area [B] than the area 126 between adjacent linkages 120 within the rows 124, which has a larger flow area [A]. Accordingly, when the stream 113 enters into a narrower flow area the stream 113 will contract or undergo a contraction phase 111 and become converging or impinging jet streams 94 in the narrowed flow area. When the stream 113 enters into a larger flow area, the stream 113 will expand or undergo an expansion phase 112 and become non-impinging jet streams 70 in the larger flow area. Notably, the exemplary embodiments of the linkages 120 and areas 125, 126 and stages 110 as depicted and described for FIGS. 7 and 8 both have anti-cavitation and noise reduction capabilities.

In the preferred exemplary embodiment as shown in FIG. 7, the initial flow 113 undergoes expansion 112 as the flow 113 bifurcates into two streams at the area 125 between rows 124. The stream 113 experiences expansion and becomes non-impinging streams 70 in the area 125, which in FIG. 7 is an expansion flow area 112. Then, moving downstream, the non-impinging streams 70 become converging streams 94 as the stream 113 enters the contraction flow area 111 (in area 126 defined between the linkages 120 in each row 124). The flow area 126, in the exemplary embodiment of FIG. 7 consistently falls below the combined flow area 125. The flow area 125 remains constant across the trim or cartridge 100, while the flow area 126 gradually increases, leading to a cyclic pattern of expansion 112 and contraction 111 that results in staged pressure reduction at each subsequent pressure dropping stage 110. The cartridge 100 facilitates the mixing of jet streams 113 from different flow paths, contributing to the dissipation of additional energy within the valve 10 and/or cartridge 100.

In the alternative exemplary embodiment of FIG. 8, the initial flow 113 undergoes contraction 111 as the flow 113 bifurcates into two streams at area 125 between rows 124 of linkages 120. The stream 113 within the area 125 are converging jet streams 94. Then, moving downstream, the flow 113, previously contracted, experiences expansion 112 as it transitions into the area 126 between adjacent linkages 120 in the rows 124. In the expansion phase 112, the stream 113 are non-impinging jet streams 70. In the exemplary embodiment of FIG. 8, the flow area 126 consistently exceeds the combined flow area 125. The flow area 126 remains constant across the trim, while the cumulative flow area 125 gradually expands, leading to a cyclical pattern of expansion phases 112 and contraction phases 111 that results in staged pressure reduction at each subsequent pressure dropping stage 110. The alternative exemplary embodiment of the cartridge 100 of FIG. 8, like the exemplary embodiment of the cartridge 100 in FIG. 7, also facilitates the mixing of jet streams 113 from different flow paths, contributing to the dissipation of additional energy within the valve 10 and/or cartridge 100.

The flow-facing edges 133a of the polygonal elements 130 play a crucial role in inducing stream or flow 113 bifurcation, effectively dividing the flow 113 into two distinct paths. These split streams 113 are directed toward the interstitial space or area 126 between the parallel faces 133b of adjacent polygonal elements 130, causing the intermixing of the flow streams 113. The frequent alterations in flow 113 direction within this space or area 126 contribute to the dissipation of kinetic energy, resulting in a noticeable reduction in flow 113 velocity. As the flow streams 113 splits into multiple paths will leads to considerable reduction in noise levels.

Within each pressure dropping stage 110 nested within the cartridge 100, there exists an expansion area 112 and contraction area 111. In these zones or pressure dropping stages 110, the fluid 113 experiences both expansion 112 and contraction 111. As the flow 113 expands, the flow 113 pressure diminishes, and conversely, as the flow 113 contracts, some of the flow 113 pressure is recovered. However, the reduction of flow 113 pressure during expansion 112 poses a potential risk of dipping below the vapor pressure of the liquid, giving rise to the formation of bubbles that may implode and induce cavitation during the subsequent pressure recovery in the contraction area 111. This phenomenon is prevented by ensuring precise dimensions for the expansion areas 112 and contraction areas 111 within the cartridge 100, achieved through design calculations and computational fluid domain analysis.

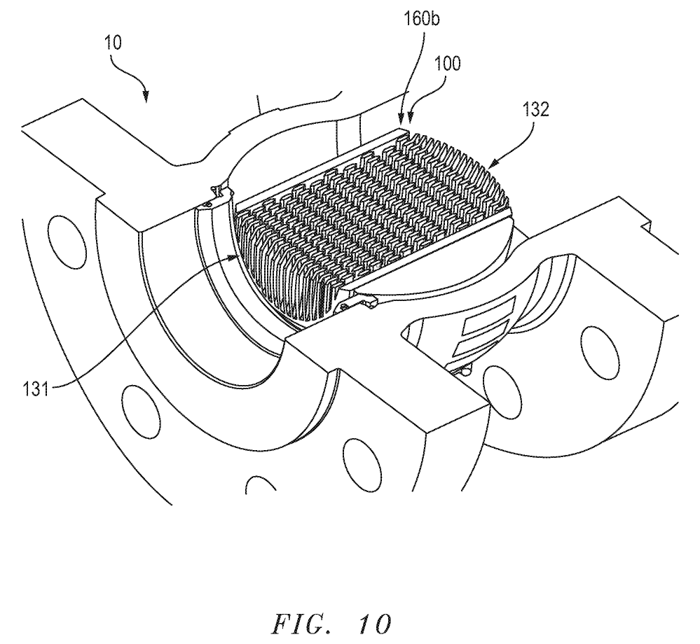

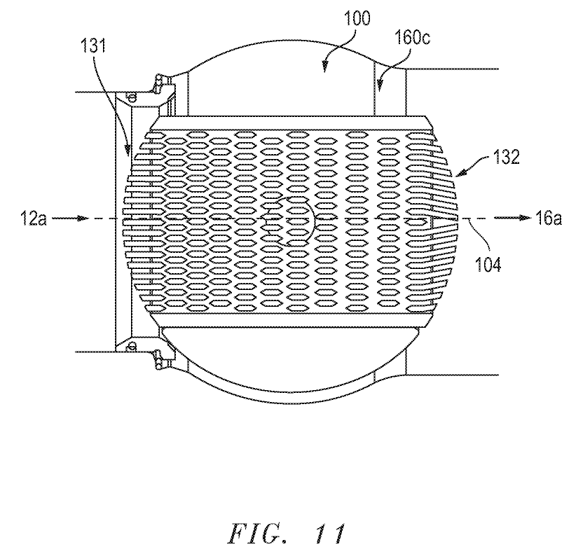

An alternative exemplary embodiment of a cartridge 160b is illustrated in FIGS. 9-10. The cartridge 160b may have the same or similar linkages 120, 120a or plates 130 as earlier exemplary cartridge 160a (wherein the linkages 120, 120a or plates 130 are oriented orthogonal or perpendicular to the flow 113 direction defined from the cartridge upstream end 102a to the cartridge downstream end 102b). However, the alternative exemplary embodiment of cartridge 160b includes one or both of entry plates 131 and exit plates 132 which are angled, which are located at the upstream edge 102a, and downstream edge 102b, respectively. The entry plates 131 of the cartridge 160b are angled so as to facilitate the inward flow 113 into the cartridge 160b. The exit plates 132 are angled so as to prevent flow 113 (which may contain potential bubbles or cavitation in said flow 113) from impacting or hitting the valve body 18 upon leaving the cartridge 160b. The alternative exemplary embodiment of the cartridge 160b provides an advantage particularly in scenarios involving erosive media and operations in low lift conditions.

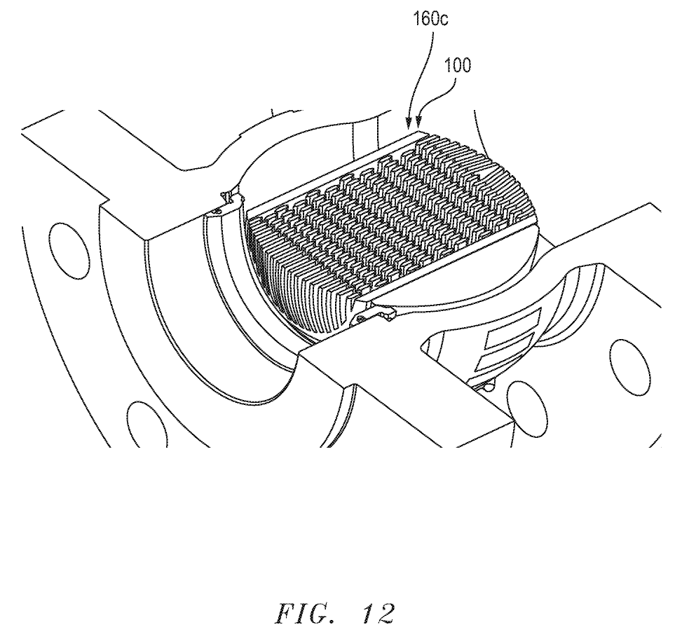

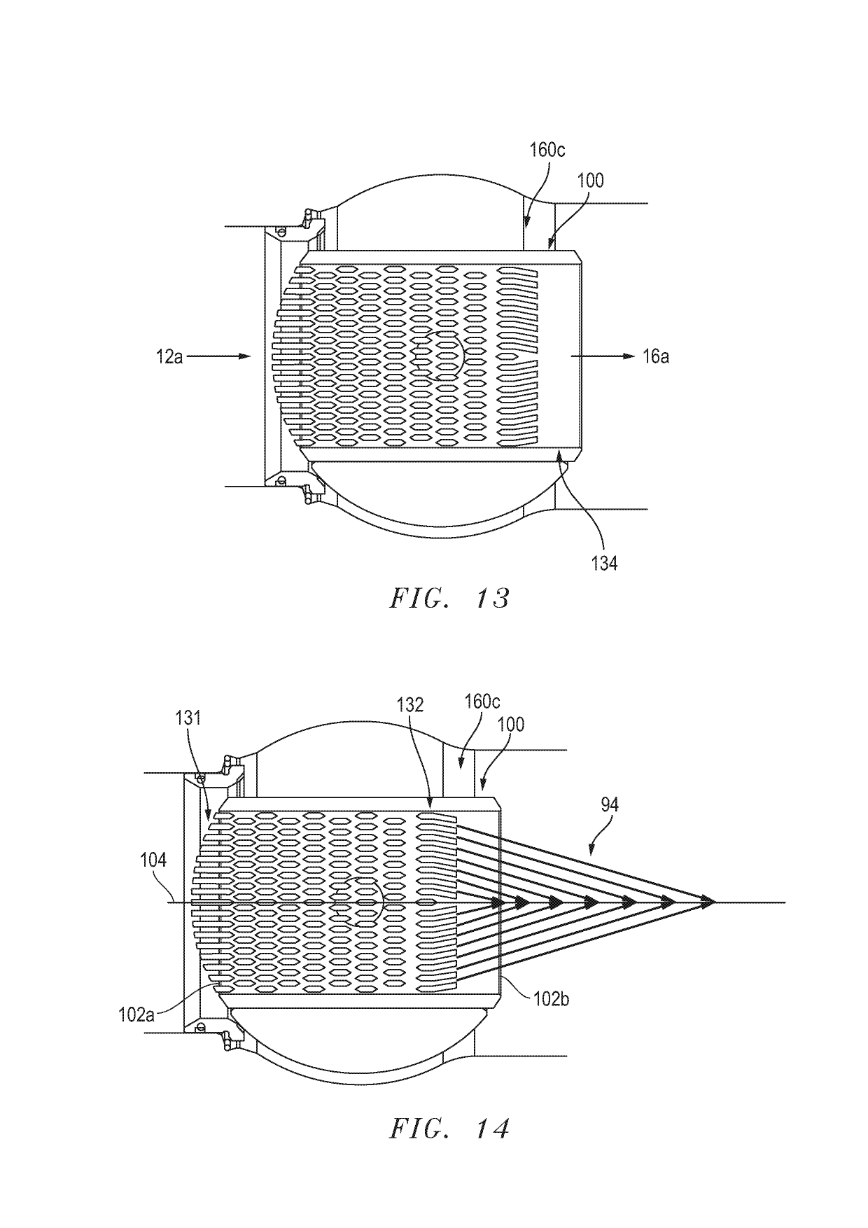

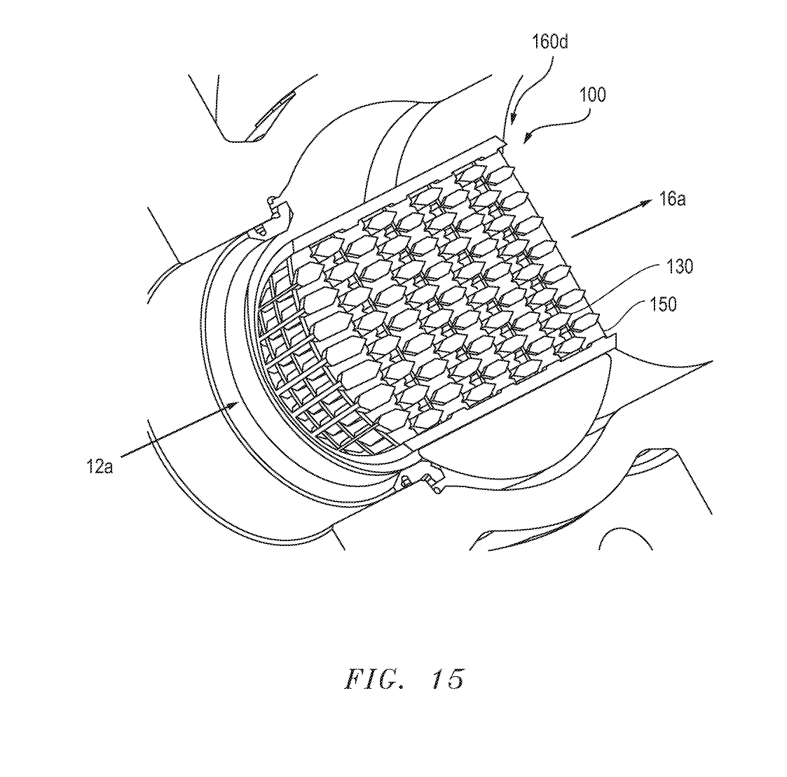

A further alternative exemplary embodiment of a cartridge 160c is illustrated in FIGS. 11-14. The cartridge 160c may have the same or similar linkages 120, 120a or plates 130 as earlier exemplary cartridges 160a-160b (wherein the linkages 120, 120a or plates 130 are oriented orthogonal or perpendicular to the flow 113 direction defined from the cartridge upstream end 102a to the cartridge downstream end 102b ). However, the alternative exemplary embodiment of cartridge 160c includes entry linkages or plates 131 and exit linkages or plates 132, wherein the exit linkages or plates 132 are angled towards a central plane 104 and the entry plates 131 are straight or aligned with the upstream flow direction 12a and downstream flow direction 16a. The exit plates 132 converge the flow 113, and the entry plates 131 guide the flow 113 into the cartridge 160c. The entry plates 131 are located at the upstream edge 102a for exemplary embodiments of the cartridge 160c; however the exit plates 132 may by optionally located at the downstream edge 102b (see, e.g. FIGS. 11-12), or alternatively, within the interior of the cartridge 160c, wherein the exit plates 132 terminate at a distance 134 from the downstream edge 102b (see, e.g. FIGS. 13-14). The exiting jets 113 of cartridge 160c converge toward the central plane 104, serving to safeguard the valve body 18 wall and piping (not shown) in the event of cavitation at the final stage. When the exit linkages or plates 132 are positioned at a distance 134 away from the downstream edge 102b, the valve body 18 may be even more or further protected from any potential residual cavitation, as a portion or percentage of any such cavitation would instead resolve or converge within the distance 134 of the cartridge 160c, and not hit the valve body 18 upon exit of the cartridge 160c.

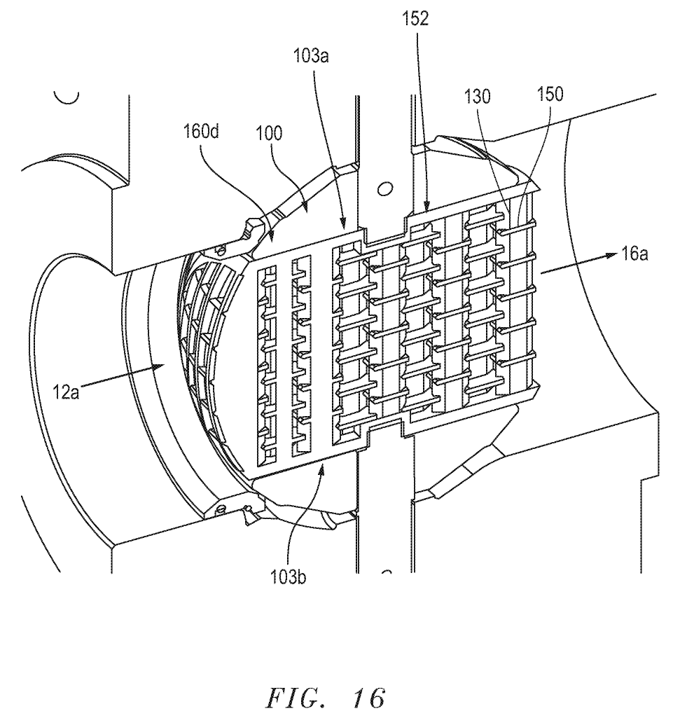

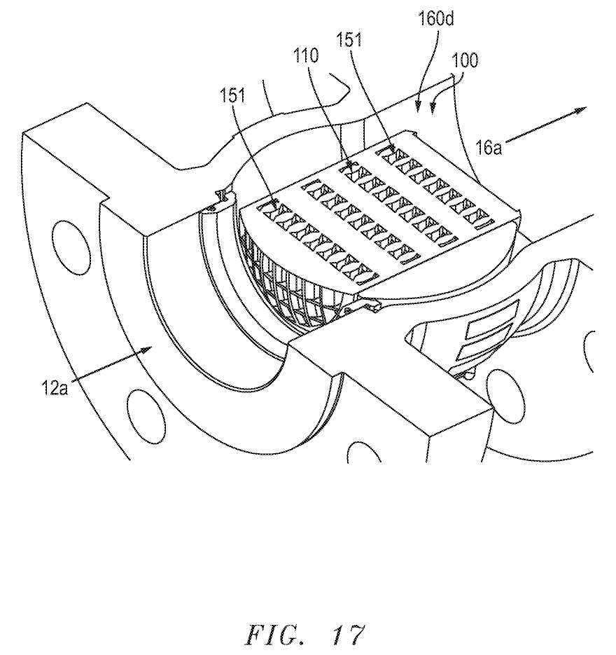

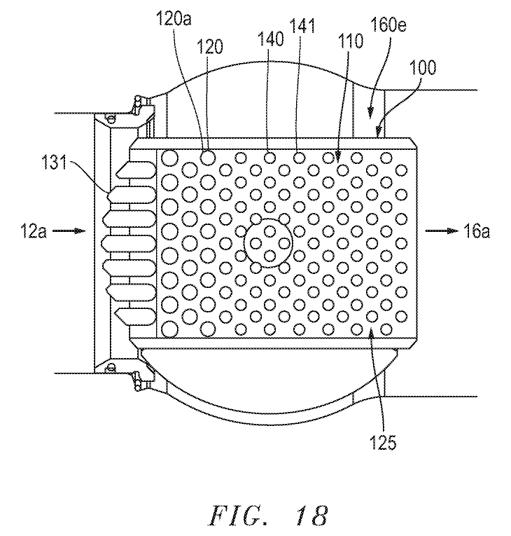

A further alternative exemplary embodiment of a cartridge 160d is depicted in FIGS. 15-17. FIGS. 15 and 17 depict different top perspective views of a top cross section of the segmented rotary control valve 10 with cartridge 160d; and FIG. 16 depicts a front perspective view of a side cross section of the cartridge 160d of FIGS. 15 and 17. The cartridge 160d may have the same or similar linkages 120, 120a or plates 130 as earlier exemplary cartridges 160a-160c (wherein the linkages 120, 120a or plates 130 are oriented orthogonal or perpendicular to the flow 113 direction defined from the cartridge upstream end 102a to the cartridge downstream end 102b), and further includes a staggered extensions or protrusions 150 orthogonal to the upstream flow 12a and downstream flow 16a, and wherein the protrusions 150 are also orthogonal to the linkages 120, 120a, or plates 130 and are located or situated on the linkages 120, 120a, or plates 130. As can be seen in FIG. 16, the vertical column 152 defined between each staggered row 124 of plates 130 includes staggered protrusions 150 along the vertical length of the plates 130 which connects the top half 103a of the cartridge 160d to the bottom half 103b of the cartridge 160d. The protrusions 150 of the downstream or subsequent plates 130 are offset, or unaligned from the protrusions 150 of the upstream or prior plates 130. The vertical column 152 between polygonal links 130 is thus compartmentalized or sectioned via the protrusions 150 into compartments 151 (see FIG. 17), in order to achieve a more effective pressure drop and improve the structural rigidity of the links 120 or plates 130 to handle higher pressure drop. These compartments 151 are offset between adjacent rows 124 or stages 110 in order to strategically and effectively achieve staged and gradual pressure drops (i.e. such as, across a single top or bottom cross section view as showing in FIG. 17, the compartments 151 may appear in every other row 124 of this cross-section). The protrusions 150 are set at a same distance from each other on the plurality of linkages 120 at a downstream end 102b of the cartridge body 105 compared to the protrusions 150 on each of the linkages 120 at an upstream end 102a of the cartridge body 105. By way of example only, the compartments 151 are strategically organized to force the flow or stream 113 to take a path or turn, by way of example, a 90 degree turn, from one compartment 151 into a subsequent compartment 151 as the flow 113 travels downstream in each stage 110. Further, the compartments 151 may increase in size or area as the compartments 151 approach or near the downstream end 102b, as compared with compartments 151 nearer the upstream end 102a. The cartridge 160d may be able to handle larger pressure drops as compared with other disclosed cartridges herein (such as exemplary embodiments of cartridges 160a-160c).

In a further alternative exemplary embodiment of the anti-cavitation and low-noise cartridge trim 160e and as depicted in FIGS. 18-20, rods 140 having a circular cross section 141 are employed inside the cartridge 160e instead of polygonal elements or plates 130. This alternative exemplary embodiment of the cartridge 160e offers an advantage for fabrication in larger sizes as opposed to utilizing three dimensional (3D) printing, resulting in a cost-effective solution. Somewhat similarly to earlier alternative exemplary embodiments of the cartridge 100 and 160a-160d, the cartridge 160e has linkages 120, 120a or rods 140 oriented orthogonal or perpendicular to the flow 113 direction defined from the cartridge upstream end 102a to the cartridge downstream end 102b, and the rods 140 may optionally decrease in size or cross section 141 towards the downstream end 102b of the cartridge 160e (if flow area 125 is larger than flow area 126). The rods 140 are also positioned at an offset or unaligned position in each subsequent or downstream row 124 from the prior or upstream row 124 and also induce gradual pressure drop stages 110 similar to as described for earlier cartridge exemplary embodiments 160a-160d as the flow 113 experiences contraction cycles 111 and expansion cycles 112 traveling through flow areas 125 and flow areas 126. The cartridge 160e may optionally include entry plates 131 to guide the flow 113 into the cartridge 160e interior and towards the rods 140.

In yet an additional alternative exemplary embodiment of the anti-cavitation and low-noise cartridge trim 160f, a first set of linkages 120a or rods 140 and a second set of linkages 120b or rods 140 are utilized as in the exemplary embodiment of the cartridge 160e. The first set of linkages 120, 120a are oriented orthogonal or perpendicular to the flow 113 direction defined from the cartridge upstream end 102a to the cartridge downstream end 102b, as organized into rows or groups 124, wherein the first linkage 120a in the row 124 is towards a front 106 of the cartridge 160f, and the last linkage 120a in the row 124 is towards a rear 107 of the cartridge 160f. In the anti-cavitation and low-noise cartridge trim 160f, the second set of linkages 120, 120b or rods 130 are oriented orthogonal or perpendicular to the first set of linkages 120a, and are also oriented orthogonal or perpendicular to the flow 113 direction defined from the cartridge upstream end 102a to the cartridge downstream end 102b. The second linkages 120b are also organized into stacked vertical rows or groups 124, wherein the first linkage 120b of the row 124 is towards a top half 103a of the cartridge 160f, and the last linkage 120b of the row 124 is towards the bottom half 103b of the cartridge 160f. The second set of linkages 120b connect a front end 106 of the cartridge 160f at one end of a linkage 120b, to a rear or back end 107 of the cartridge 160f at the second end of the linkage 120b. Thus these two sets 120a, 120b of circular rods 140 are welded together in a crisscross pattern to enhance the efficiency of pressure reduction. The rods 140 of the linkages 120a and 120b are also positioned at an offset or unaligned position in each subsequent or downstream row 124 from the prior or upstream row 124 and also induce gradual pressure drop stages 110 similar to as described for earlier cartridge exemplary embodiments 160a-160e. In other words, the linkages 120a in each subsequent downstream row 124 are offset, unaligned, or non-parallel from the position of the linkages 120a in the prior, upstream row 124. By way of example only, the first of the linkages 120a in a downstream or subsequent row 124 may be shifted closer or farther away towards the front 106 than the first of the linkages 120a in a prior, upstream, or earlier row 124. Further, the linkages 120b in each subsequent downstream row 124 are offset, unaligned, or non-parallel from the position of the linkages 120b in the prior, upstream row 124. By way of example only, the first of the linkages 120b in a downstream or subsequent row 124 may be shifted closer or farther away towards the top 103a than the first of the linkages 120b in a prior, upstream, or earlier row 124.The alternative exemplary embodiment of the cartridge trim 160f offers significant benefits, especially when applied to larger sized systems. The flow 113 experiences deliberate changes in direction along two perpendicular planes as it progresses from one stage 110 to the next downstream stage 110. The alternative exemplary embodiment of cartridge 160f proves advantageous for fabrication in larger sizes, providing a more effective means of inducing pressure drop while optimizing fluid 113 flow through controlled directional changes. The first set of linkages 120a and second set of linkages 120b may optionally both decrease in size or cross section 141 towards the downstream end 102b of the cartridge 160f if the flow area 125 is larger than flow area 126 for each set of linkages 120a, 120b. The cartridge 160f may optionally include entry plates 131 to guide the flow 113 into the cartridge 160f interior and towards the rods 140.

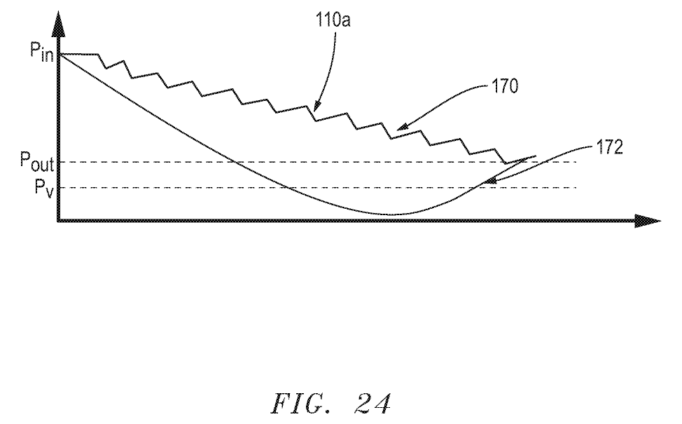

FIG. 24 depicts a graph comparing the pressure of an exemplary fluid flow 113 in a segmented rotary control valve 10 having an exemplary embodiment of a cartridge trim 100 for anti-cavitation and low noise, and a fluid flow for a conventional or commercially available segmented rotary control valve. In the FIG. 24 the vertical axis or y-axis of the graph represents the pressure of the liquid, wherein Pᵢₙ represents the pressure of the liquid as it enters into the segmented rotary control valve, Pₒᵤₜ represents the pressure of the liquid as it exits into the segmented rotary control valve, and Pᵥ represents the vapor pressure of the liquid. The horizontal axis or x-axis of graph represents the distance between the inlet port 26c and outlet port 26d of the valve 10. The stepped line 170 of the graph shows an exemplary embodiment of the progression of the pressure of the fluid 113 as the fluid 113 travels through the segmented rotary control valve 10 having an anti-cavitation and low noise cartridge trim 100 and/or 160a-160f. The curved line 172 of the graph shows the progression of the pressure of a fluid as the fluid travels through a segmented rotary control valve without any anti-cavitation and low noise cartridge trim 100 or 160a-160f. As can be seen in comparing the stepped line 170 to the curved line 172, usage of the anti-cavitation and low noise cartridge trim 100 and/or 160a-160f prevents the pressure of the fluid 113 from ever dropping below the vapor pressure or Pᵥ, of the fluid, thus eliminating or mitigating the potential for cavitation or bubbles within the fluid 113 for the segmented rotary control valve 10 or segmented ball valve 10a. Conversely, for the curved line 172 for the conventional ball valve, without the trim 100 as disclosed herein, the pressure of the fluid can drop significantly below the vapor pressure of the fluid or liquid, thus introducing damaging cavitation or bubbles into the fluid, which can damage the valve system. The effects of the pressure drop stages 110 in the above described exemplary embodiments of the cartridges 100 and 160a-160f can also be visualized with each step 110a in the pressure graph as seen in FIG. 24. Each pressure drop 110 causes the pressure of the fluid 113 in the stepped graph 170 to decrease by a gradual step 110a. As can be seen by the number of steps 110a in FIG. 24, there are twelve (12) pressure stages 110 in the exemplary embodiment of the cartridge 100 used in FIG. 24. As described earlier, the disclosure herein can encompass more or less pressure drop stages 110 as desired. The gradually, stepped decrease of the pressure of the fluid 113 helps prevent the fluid 113 from dropping below the vapor pressure of said fluid 113.

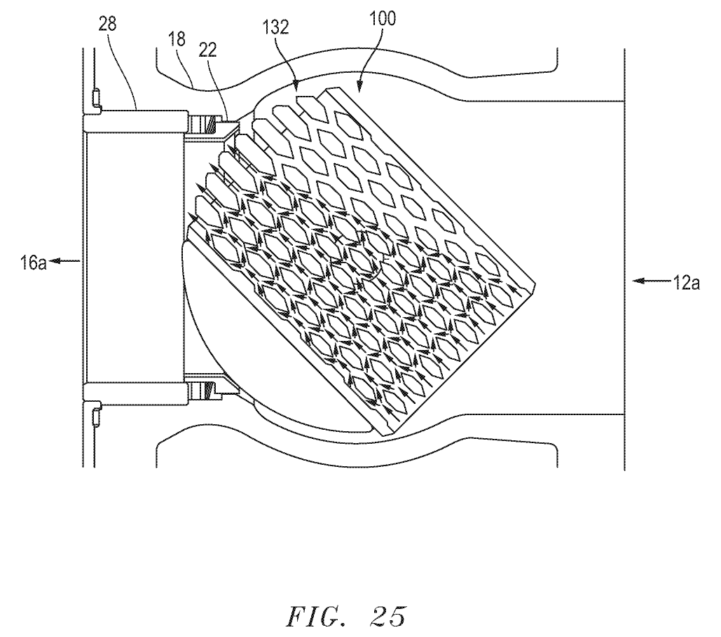

FIG. 25 depicts a top view of the cross section of an exemplary embodiment of a segmented rotary control valve 10 with an exemplary embodiment of a cartridge trim 100 for anti-cavitation and low noise shown in one modulating or partially opened position in a shaft upstream 12a direction (or reverse flow) with an exemplary embodiment of a hardened liner 28 on the valve body 18, wherein the liner 28 may be adjacent to a downstream 16a valve seat 22, at the downstream 16a position or exit of the valve body 18 or cartridge 100. The anti-cavitation low-noise cartridge 100 is designed for use in the shaft upstream 12a flow direction as well, as shown in FIG. 25. While the cavitation trim 100 is intended to eliminate cavitation, cavitation can still occur in the final stage in certain scenarios. In the event of cavitation at the cartridge 100 exit, a hardened material liner 28 protects the valve’s 10 downstream 16a side, ensuring that downstream 16a components remain safeguarded from potential damage. This reverse flow configuration (or shaft upstream direction) of the cavitation trim 100 prevents high velocity clearance flow near the exit plate 132 edges, a potential issue in the shaft downstream configuration (a shaft downstream configuration is shown, by way of example, in FIG. 3), and helps protect the valve body 18 from damage. The potential issue of clearance flow in the shaft downstream configuration in FIG. 3 may be overcome by reversing flow to the shaft upstream direction or configuration as shown in FIG. 25. In the alternative exemplary embodiment as depicted in FIG. 25, the number of linkages may decrease or be the same or increase across rows 124, or alternatively, the number of intermixing areas may decrease or be the same or increase across the rows 124, as the flow moves from the right to the left of the FIG. 25 (or upstream 12a to downstream 16a).

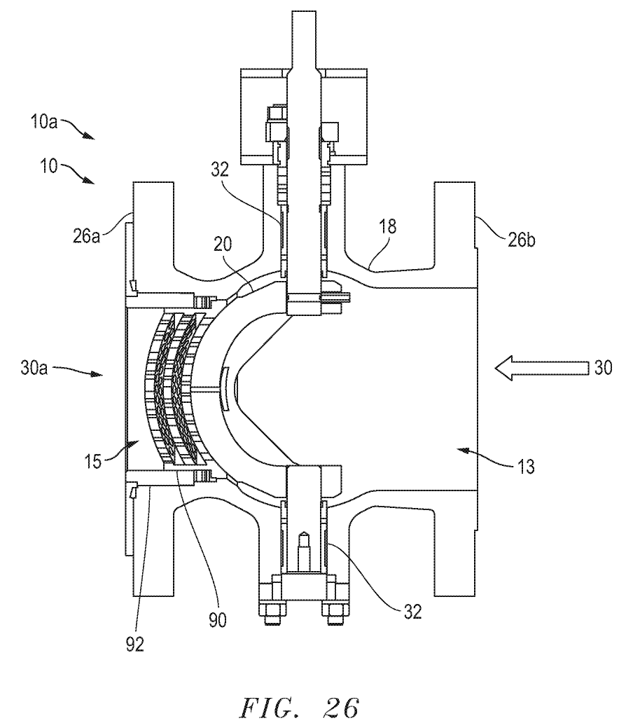

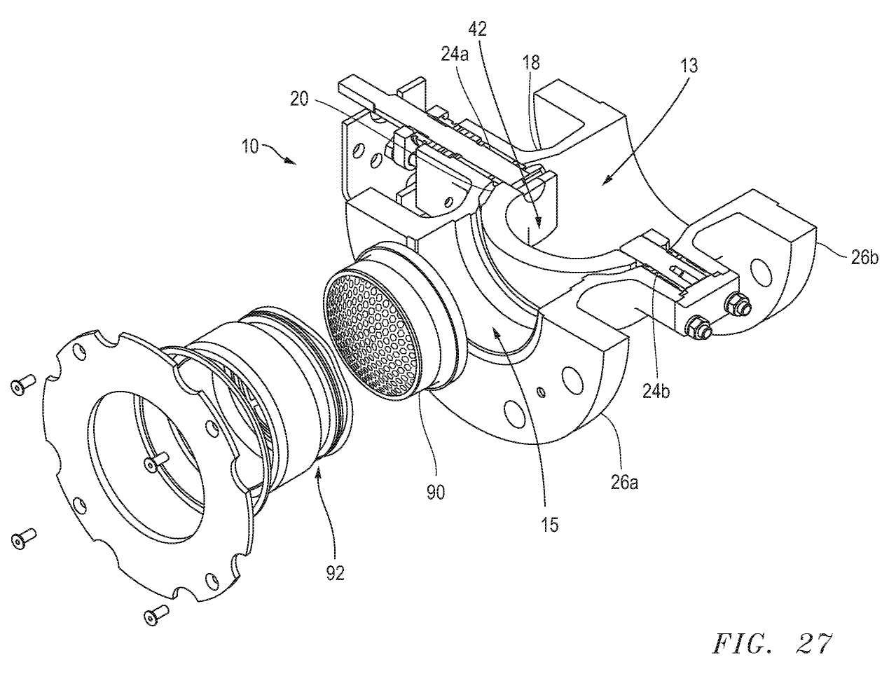

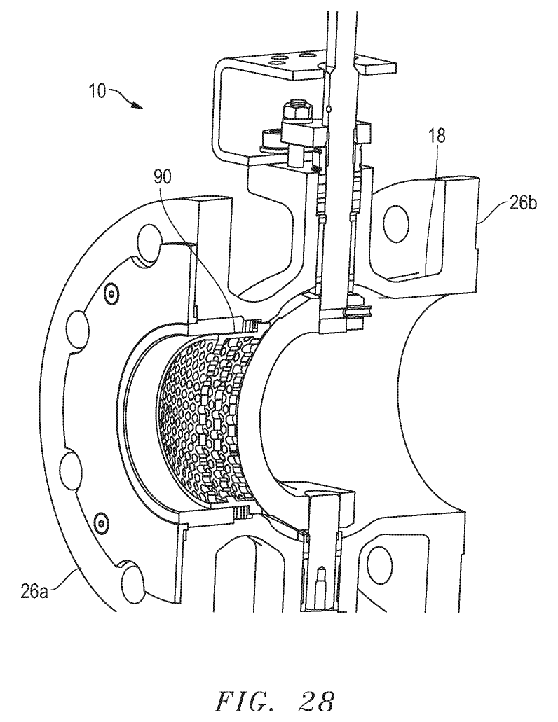

FIGS. 26-28 depicts various views of a segmented rotary control valve 10 with an exemplary embodiment of segmented ball valve 10a having an improved seat 90 for anti-cavitation and low noise. FIG. 27 shows the valve 10 or 10a in an exemplary embodiment during assembly, disassembly, or replacement of an exemplary embodiment of a seat 90 for anti-cavitation and low noise. In the presently described embodiments, the rotary control valve 10 and segmented valve 10a is a bidirectional valve having a preferred directional flow path 30 through the seat 90. It is to be noted that the segmented rotary control valve 10, is not usually fully closed and neither is it usually fully open wherein the direction of flow is one direction. Rather the segmented rotary control valve 10 is normally modulating between a variety of positions there-between a fully closed position and a fully open position.

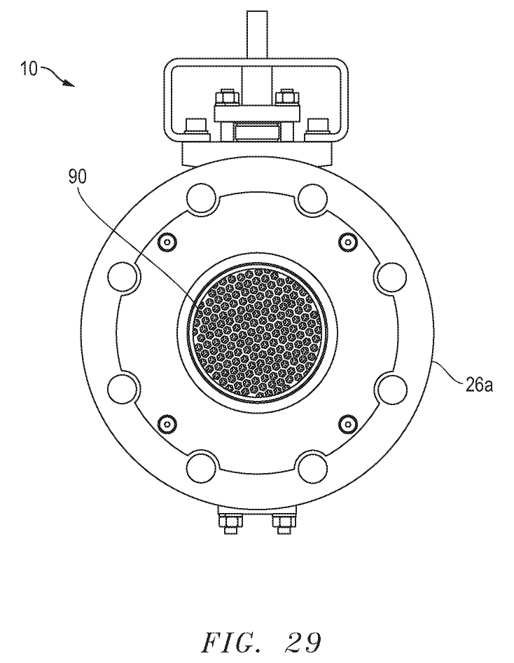

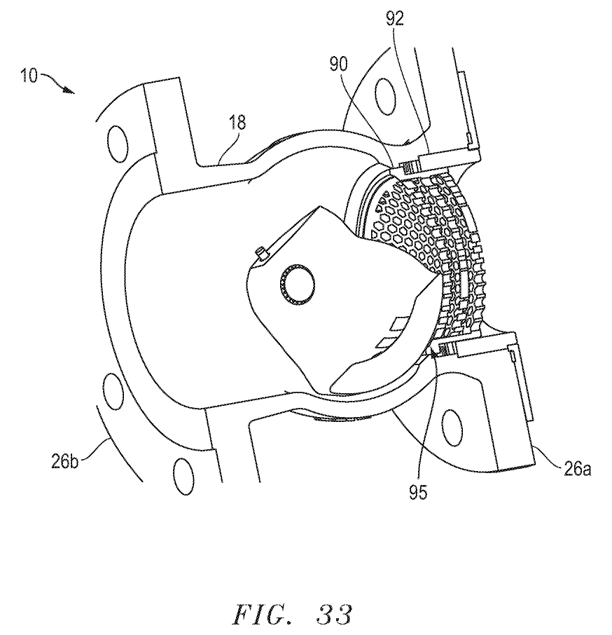

The segmented rotary control valve 10 in the FIGS. 26-33 has a valve body 18, a segmented ball or other control element 20, an improved seat 90, and may include upper valve stem 24a and lower valve stem 24b, and two connector ends 26a, 26b. The connector end 26a defines a relatively smaller diameter valve outlet port 15 to the valve body 18, and consequently flow path 30, relative to connector end 26b which defines a relatively larger diameter inlet port 13 to the valve body 18 and consequently flow path 30. The segmented ball 20 may be, in certain exemplary embodiments of the FIGS. 26-33, a standard segmented ball.

In the closed position, the segmented ball 20 is rotated thereby sealing the flow path 30 with a solid portion of the segmented ball 20 against the seating surface 93a of the improved seat 90. In an open or partially open position of the valve 10, achieved via rotation of the segmented ball 20, fluids are able to flow through the segmented ball valve 10a via the flow path 30 and through the improved seat 90. The segmented ball 20 may define a hollow, chamber, or cavity 42 such as a bore 42 on the segmented ball 20 that allows the flow of fluid through the improved seat 90 when the valve 10 is in an open or modulating position. The cavity 42 passes entirely through the segmented ball 20. The upper valve stem 24a and lower valve stem 24b may penetrate the valve body 18 through an access way 32 in the valve body 18. An actuator (not shown) may couple to the upper valve stem 24a in order to actuate the segment ball 20 between a variety of open positions and the closed position. The connector ends 26a, 26b as shown are configured for connection to piping (not shown). The connector ends 26a, 26b may be any suitable connection including, but not limited to, welding, butt welds, socket welds, bolt on flanges, and the like.

Referring to the exemplary embodiments of FIG. 27 the segmented rotary control valve 10 is assembled or disassembled with the upper stem 24a and the lower stem 24b pushed or pulled through the segmented rotary control valve 10 and the segmented ball 20, and with the seat 90 installed separately of the segmented ball 20 to enable respective assembly, disassembly, and replaceability of seat 90 (by contrast in the prior art there is a great deal of difficulty, due to interference, of assembling a fully welded/integrated type noise attenuator into a valve). It is to be noted that the upper stem 24a and the lower stem 24b will remain in the segmented ball 20 during the assembly or disassembly of the seat 90, and hence the segmented ball 20 shall remain in place within the segmented rotary control valve 10 during the assembly, disassembly, and/or replacement of the seat 90. The improved seat 90 is inserted through and into the valve 10 outlet end or port 15. The improved seat 90 may be installed adjacent to an optional liner 92 in the outlet port 15 for protecting the valve body 18. The liner 92 may act as a protection for residual cavitation, if any.

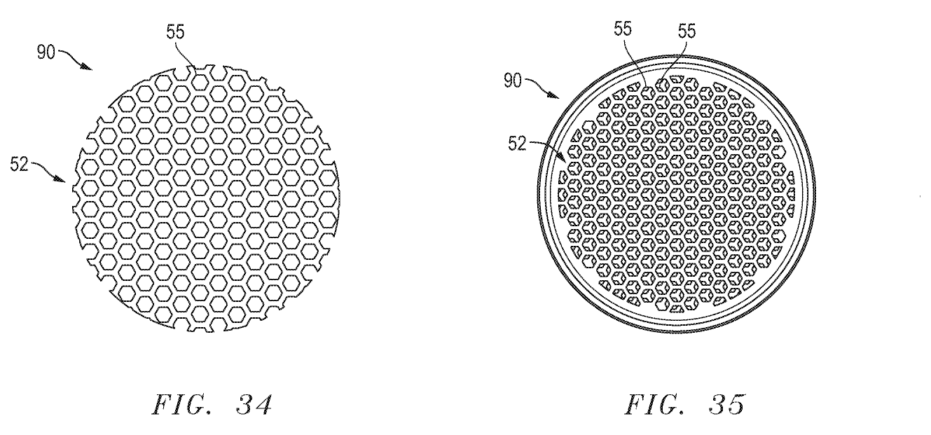

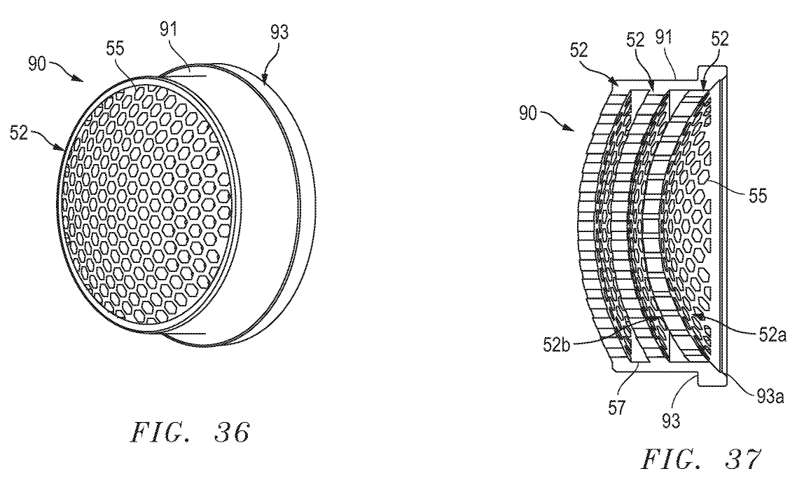

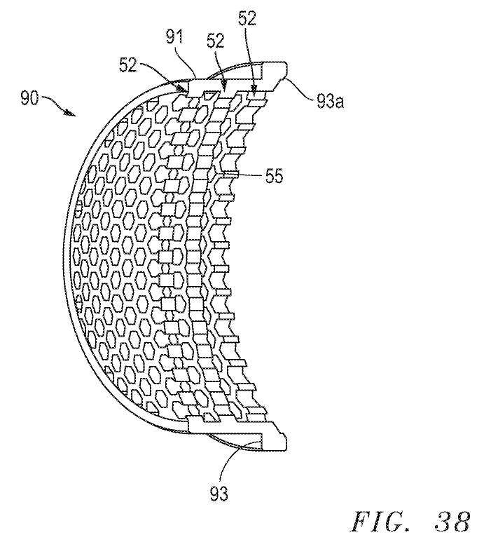

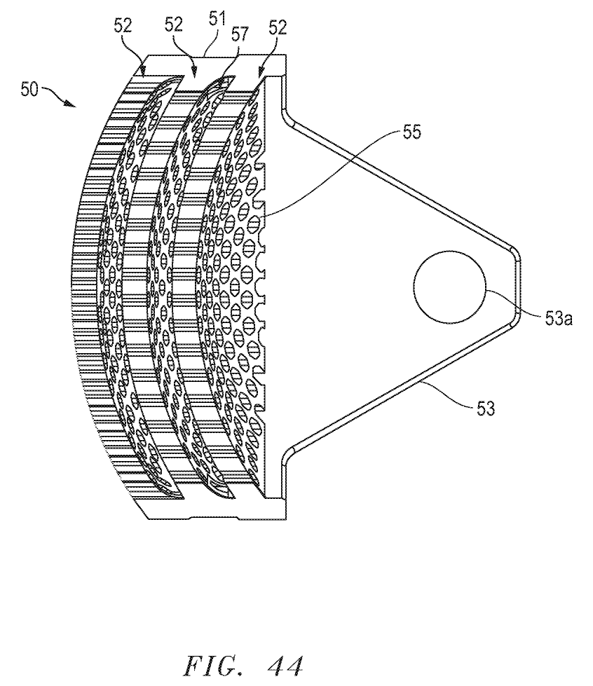

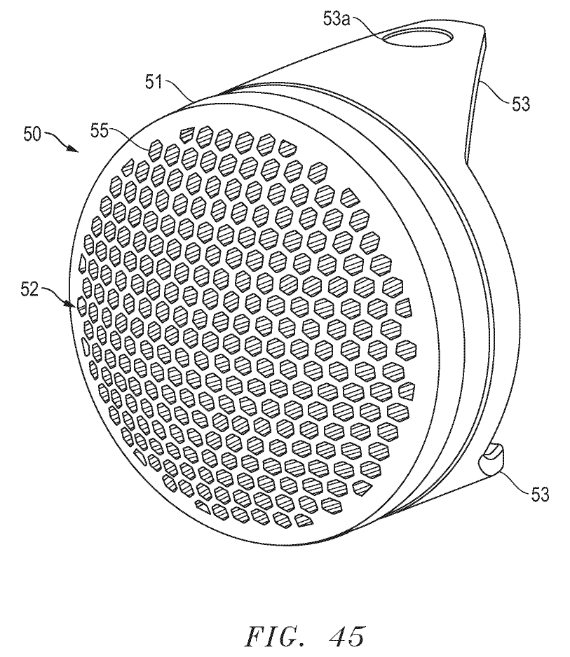

The segmented ball valve 10a specifically engineered for anti-cavitation and noise reduction purpose uses a replaceable and removable seat 90 which is securely positioned within the outlet port 15, and wherein the improved seat 90 has a substantially open cylindrical shaped seat body 91 which defines an exterior shoulder 93 and a seating surface 93a as better seen in FIGS. 36-38. The seating surface 93a engages the solid portion of the ball 20 in the modulating positions and the closed position of the valve 10, preventing flow from moving past the portion of the seating surface 93a in connection with the solid portion of the ball 20. In the fully closed position, the seating surface 93a is fully sealed against the ball 20. The seating surface 93a may be directly neighboring or adjacent to the circumference or perimeter of the most upstream facing curved plate 52. There may be a gap 95 between the ball 20 surface and the concave surface 52a of the curved plate 52. The seat 90 incorporates one or more curved plates 52 arranged in sequence within the seat body 91, with a gap 57 between each curved plate 52 and its subsequent neighboring curved plate 52, which can be seen in greater detail in FIGS. 37-38. The upstream-most curved plate 52 may face the oncoming flow 30 with its concave surface 52a; the same curved plate 52 will have its convex surface 52b facing the concave surface 52a of the subsequent downstream plate 52, and so on. Each gap 57 may be substantially defined by the interior surface of the seat body 91 and the convex surface 52b of the upstream curved plate 52, and the concave surface 52a of the downstream curved plate 52. For a flow direction 30a, the upstream most curved plate 52 will face the flow direction 30a with its convex surface 52b, and the same curved plate 52 will have its concave surface 52a facing the convex surface 52b of a subsequent downstream plate 52, and so on. In such exemplary embodiments for a flow direction 30a, the port 13 may be an outlet port, and the port 15 may be an inlet port. As depicted in the enlarged view in FIGS. 35 and 37-38, each curved plate 52 defines a number of regularly spaced openings, apertures or orifices 55, wherein each subsequent or additional curved plate 52 contains has offset or staggered openings 55 to facilitate staged pressure reduction and effectively mitigating or eliminating the occurrence of high-intensity cavitation and noise. While the depicted exemplary embodiments of FIGS. 26-45 depict the openings 55 as hexagonal shaped openings, the openings 55 may be any polygonal-shaped openings; in further alternative exemplary embodiments, the openings 55 may be circular-shaped openings. These openings 55 may be aligned with the flow directions 30 and 30a when the segmented ball 20 or valve 10 is in the fully open position. The outlet port 15 and liner 92 are designed to accommodate the anti-cavitation and noise reduction improved seat 90; this allows for convenient field replaceability of the seat 90 with minimal effort and eliminates the need for any welding or fasteners to affix the seat 90 to the segmented ball valve 10a. This seat 90 also facilitates the utilization of the fully cylindrical access way 32 inside the port 15 for incorporating a greater number of pressure reduction stages compared to the currently available or conventional designs.

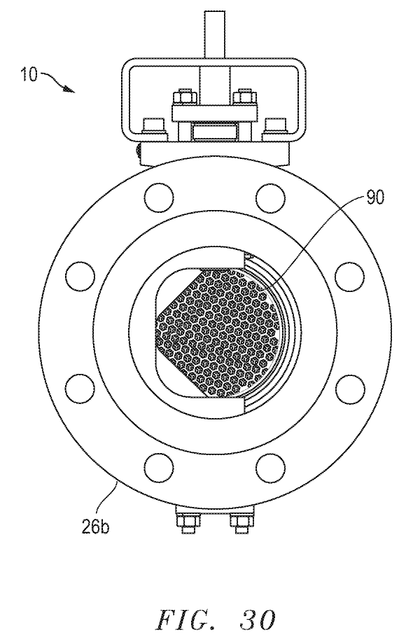

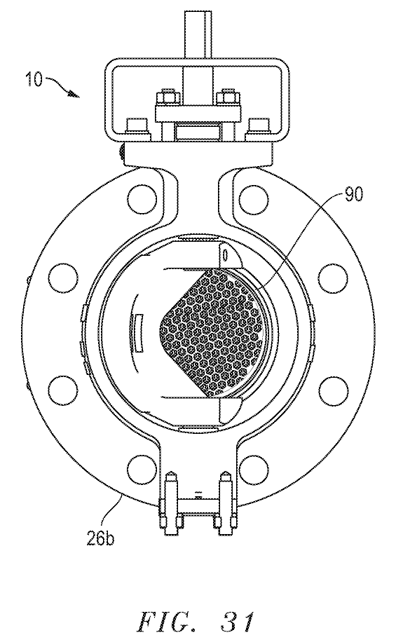

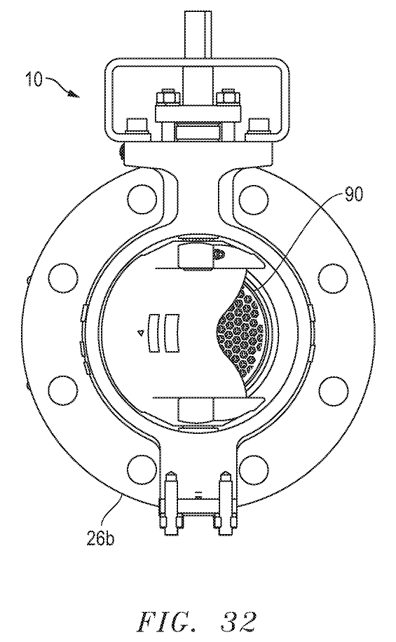

As mentioned before, unlike the conventional cavitation and noise reduction trims, in the present embodiments, the seat 90 is introduced onto the segmented ball valve 10a without the help of welding or fasteners. This improved seat 90 trim can split the pressure drop across multiple pressure reduction stages and absorb kinetic energy ensuring the pressure at any stage will not drop below the vapor pressure of the fluid, which is a key factor in cavitation. The seat 90 is preferably to be used for a unidirectional flow path 30, but is also effective at reducing cavitation and noise in a flow direction opposite to the flow 30. The seat 90 can be modulated or used in any number of partially open positions (see, e.g., FIGS. 31-33) between the fully opened (see FIG. 30) and fully closed positions. FIGS. 31-32 depict ends view of the inlet end 13 of a segmented rotary control valve 10 shown in modulating positions in an exemplary embodiment. The modulating position is a partially open position of the rotary control valve 10 which allows an upstream flow path 30 at the inlet port 13 through the segmented valve 10a through to the downstream flow path 30 at the outlet port 15.

Conventional segmented ball valves can exhibit notably low liquid pressure recovery factor (hereinafter, also referred to as “FL”) values, which leads to the occurrence of cavitation even in low pressure drop applications. However, the incorporation of anti-cavitation seat 90 has the potential to elevate the FL value closer to 1. Thus the seat 90 is enabled to handle high-pressure drops without having cavitation issues. Additionally, an increase in the number of flow paths results in a reduction in valve style modifier, or F_{d}, values, leading to decreased noise levels. Effective mitigation or elimination of cavitation and noise of the present exemplary embodiments of the improved seat 90 can be achieved by incorporating a higher number of pressure-reducing stages via an increase in the number of curved plates 52 and/or as combined with an increase in the number of apertures or openings 55 per plate 52, thus intermixing of internal jet streams.

The curved plates 52 of seat 90 are oriented perpendicular or orthogonal to the directional flow direction 30 and a flow path 30a opposite to the first flow path 30. The offset alignment of the openings 55 between the curved plates 52 effectively induce pressure drops through expansion and contraction cycles. As a result of the offset alignment, the flows 30, 30a contract within the openings 55 and expand in the gaps 57 between the circular curved plates 52. Each curved plate 52 defines both a concave surface 52a and a convex surface 52b, wherein the convex surface 52b is on the opposite side of the concave surface 52a of the curved plate 52. The openings 55 are defined through each surface 52a and 52b of the curved plate 52. The curvature of the curved plates 52 (and corresponding openings 55) direct and enable the flow 30 through the segmented ball 20, and then through the attenuator seat 90 openings 55 to effectively reduce cavitation. In case of absence of the attenuator seat 90, the pressure drops in the segmented ball 20. When attenuator seat 90 is present, the pressure drops in the attenuator seat 90 and pressure drop through segmented ball 20 is negligible.

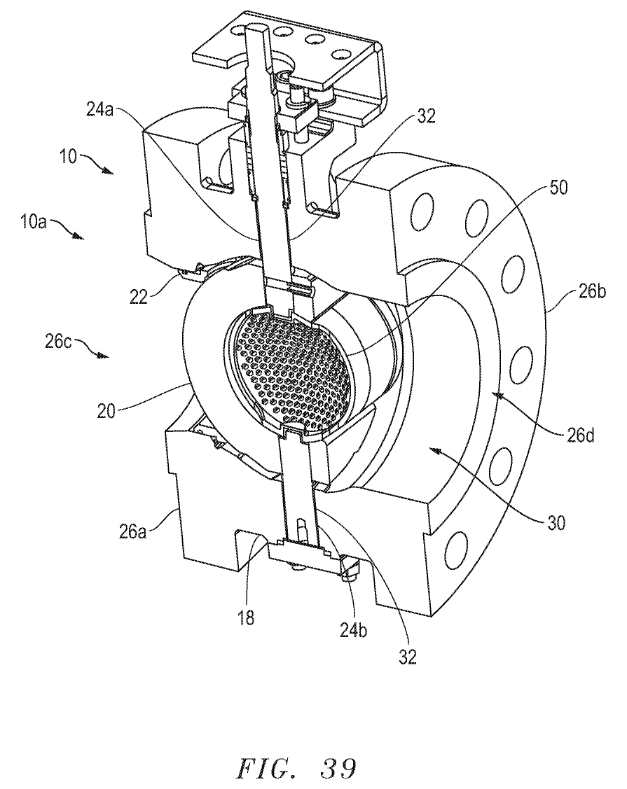

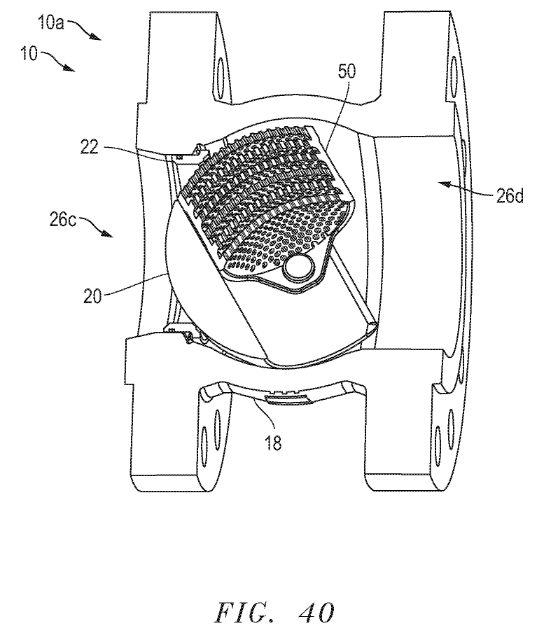

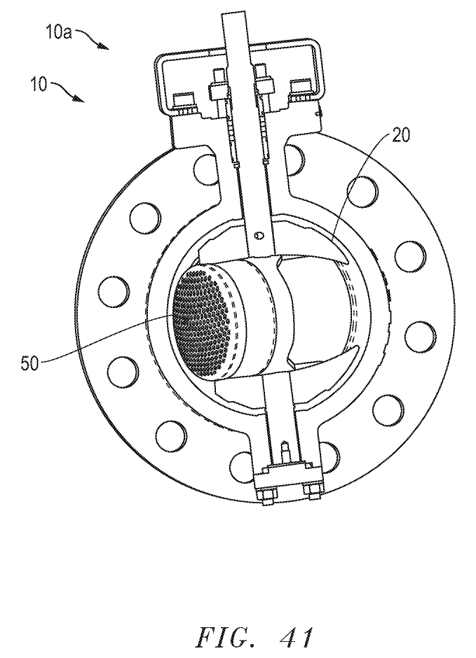

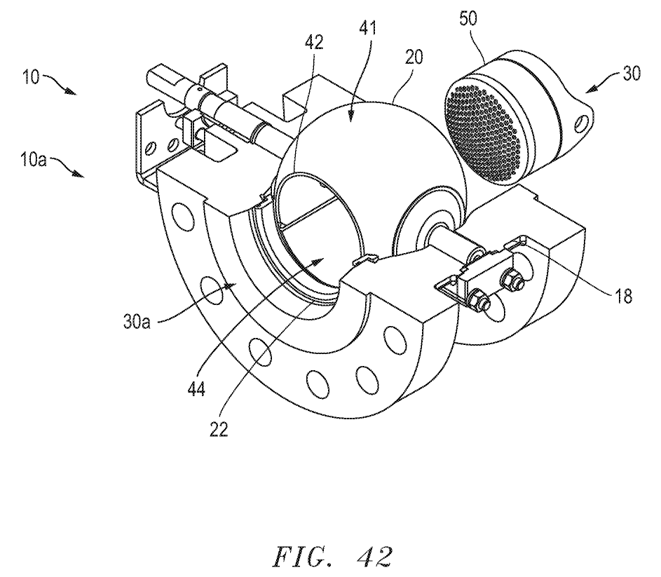

FIGS. 39-45 depict alternative views of exemplary embodiments of a segmented rotary control valve 10 with an exemplary embodiment of segmented ball valve 10a with a cartridge 50 for anti-cavitation and low noise. FIG. 42 depicts the valve 10 or 10a as shown in an exemplary embodiment during assembly, disassembly, or replacement of an exemplary embodiment of a cartridge 50 for anti-cavitation and low noise. FIG. 40 depicts a perspective view of the cross section of an exemplary embodiment of the segmented rotary control valve 10 and cartridge 50 for anti-cavitation and low noise in a modulating position. The modulating position is a partially open position of the rotary control valve 10 which allows the flow path 30 through the segmented valve 10a. In the presently described embodiments, the rotary control valve 10 and segmented valve 10a is a bidirectional valve having a preferred flow path 30 through the cartridge 50. It is to be noted that the segmented rotary control valve 10, is not usually fully closed and neither is it usually fully open wherein the direction of flow is one direction. Rather the segmented rotary control valve 10 is normally modulating between a variety of positions there-between a fully closed position and a fully open position.

The segmented rotary control valve 10 may have a valve body 18, a segmented ball 20, a valve seat 22, a cartridge 50, upper valve stem 24a and lower valve stem 24b, and two connector ends 26a, 26b. Connector end 26a defines a relatively smaller diameter opening 26c to the valve body 18 relative to connector end 26b which defines a relatively larger diameter opening 26d to the valve body 18.

In the closed position, the segmented ball 20 is rotated thereby sealing the upstream flow path 30 with a solid portion of the segmented ball 20 against the valve seat 22. In the open position, achieved via rotation of the segmented ball 20, fluids are able to flow through the segmented ball valve 10a via the flow path 30 and through the cartridge 50. The upper valve stem 24a and lower valve stem 24b may penetrate the valve body 18 through an access way 32 in the valve body 18. An actuator (not shown) may couple to the upper valve stem 24a in order to actuate the segment ball 20 between a variety of open positions and the closed position. The connector ends 26 as shown are configured for connection to piping (not shown). The connector ends 26 may be any suitable connection including, but not limited to, welding, butt welds, socket welds, bolt on flanges, and the like.

The segmented ball 20 includes a front side or profile 41 that seals against the valve seat 22 when the segmented ball 20 is in the closed position. The segmented ball 20 defines an internal hollow, chamber, or cavity such as a precision machined cylindrical bore 42 (wherein such precision machined cylindrical bore 42 is depicted in the exemplary embodiments of FIGS. 39-42) on the back side 44 of the segmented ball 20. The internal cavity 42 is adapted for receiving or to fit-in a replaceable low noise and anti-cavitation cartridge 50 within the segmented ball 20. The cavity 42 passes entirely through the segmented ball 20.

Referring to the exemplary embodiments of FIG. 42 the segmented rotary control valve 10 is assembled or disassembled with the upper stem 24a and the lower stem 24b pushed or pulled through the segmented rotary control valve 10 and the segmented ball 20, and wholly pushed or pulled out of the cartridge 50 to enable respective assembly, disassembly, and replaceability of cartridge 50 (by contrast in the prior art there is a great deal of difficulty, due to interference, of assembling a fully welded/integrated type noise attenuator into a valve without a cartridge 50). It is to be noted that the upper stem 24a and the lower stem 24b will remain in the segmented ball 20 during the assembly or disassembly of the cartridge 50, and hence the segmented ball 20 shall remain in place within the segmented rotary control valve 10 during the assembly, disassembly, and/or replacement of the cartridge 50. The upper and lower stems 24a, 24b may be pulled out slightly to facilitate the assembly of the cartridge 50 into the valve 10. The cartridge 50 of FIGS. 39-45 is inserted through the valve 10 downstream bore 26d into the closely fitting internal passage or cylindrical bore 42 of the segmented ball 20 kept in the fully open position. In one exemplary embodiment the close fit may be defined as a H7/g6 clearance or fit. The cartridge 50 may be locked within the segmented ball 20 as follows: the upper stem 24a and the lower stem 24b are then inserted into slots or openings 53a defined on ears, tabs or extensions 53 of the cartridge 50 to firmly secure and/or anchor the cartridge 50 in place through and within the segmented ball 20 and the valve body 18. The downstream opening of the valve body 18, as adjacent to the segmented ball 20, may optionally include a liner (not shown in the FIGS. 39-45) for protecting the valve body 18. The liner may act as a protection for residual cavitation, if any.

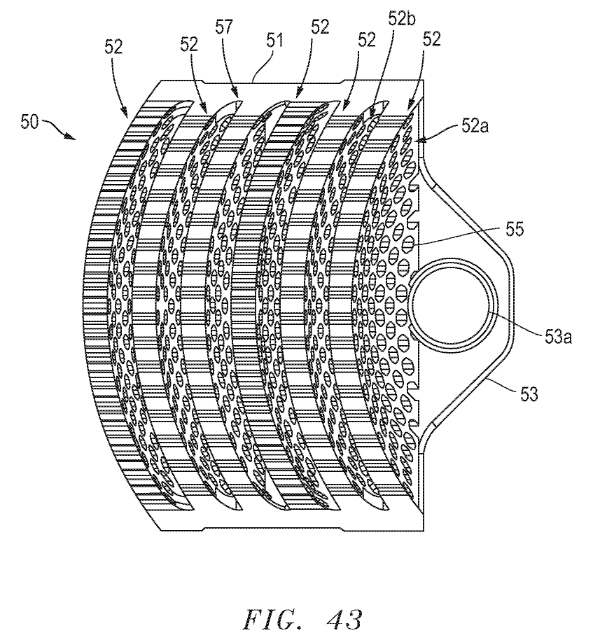

The segmented ball valve 10a specifically engineered for anti-cavitation and noise reduction purpose uses a replaceable and removable cartridge 50 which is securely positioned within the segmented ball 20, and held in place by the stem 24a and end post 24b. The cartridge 50 has a substantially open cylinder shaped cartridge body 51; the cartridge body 51 also has two ears, tabs, or extensions 53 at the top and bottom of the cartridge body 51, at an end of the series of the curved plates 52. The cartridge 50 incorporates one or more curved plates 52 arranged in sequence within the cartridge body 51, with a gap 57 between each curved plate 52 and its subsequent neighbor curved plate 52, which can be seen in greater detail in the exemplary embodiments as shown in FIGS. 43-45, similar to as described for the plates 52 in the seat 90 exemplary embodiments of FIGS. 26-38. Like the FIGS. 26-38, the upstream-most curved plate 52 faces the oncoming flow with its concave surface 52a; the same curved plate 52 will have its convex surface 52b facing the concave surface 52a of the subsequent downstream plate 52, and so on. Each gap 57 of these FIGS. 43-45 may be substantially defined by the interior surface of the cartridge body 51 and the convex surface 52b of the upstream curved plate 52, and the concave surface 52a of the downstream curved plate 52. For a flow direction 30a, the upstream most curved plate 52 will face the flow direction 30a with its convex surface 52b, and the same curved plate 52 will have its concave surface 52a facing the convex surface 52b of a subsequent downstream plate 52, and so on. Similar to the exemplary embodiments of the plates 52 in FIGS. 26-38, each curved plate 52 of FIGS. 43-45 defines a number of regularly spaced openings, apertures or orifices 55, wherein each subsequent or additional curved plate 52 contains has offset or staggered openings 55 to facilitate staged pressure reduction and effectively mitigating or eliminating the occurrence of high-intensity cavitation and noise. The openings 55 may be polygonal-shaped openings in an exemplary embodiment; in alternative exemplary embodiments, the openings 55 may be circular-shaped openings. The segmented ball 20 has a precisely machined cylindrical bore 42 designed to accommodate a slide-fit anti-cavitation and noise reduction cartridge 50; this allows for convenient field replaceability of the cartridge 50 with minimal effort and eliminates the need for any welding or fasteners to affix the cartridge 50 to the segmented ball 20. This cartridge 50 also facilitates the utilization of the fully cylindrical bore 42 inside the segmented ball 20 for incorporating a greater number of pressure reduction stages compared to the currently available or conventional designs.

As mentioned before, unlike the conventional cavitation and noise reduction trims, in the present embodiments, a cartridge 50 trim is introduced onto the segmented ball 20 without the help of welding or fasteners. This cartridge 50 trim can split the pressure drop across multiple pressure reduction stages and absorb kinetic energy ensuring the pressure at any stage will not drop below the vapor pressure of the fluid, which is a key factor in cavitation. The cartridge 50 is intended to be used for a flow path 30, but can also be used for a flow path 30a in the opposite direction of the flow path 30. Moreover, the cartridge 50 can be modulated or used in any number of partially open positions between the fully opened and fully closed positions.

Conventional segmented ball valves can exhibit notably low liquid pressure recovery factor (hereinafter, also referred to as “FL”) values, which leads to the occurrence of cavitation even in low pressure drop applications. However, the incorporation of anti-cavitation cartridge 50 trim has the potential to elevate the FL value closer to 1. Thus the cartridge 50 is enabled to handle high-pressure drops without having cavitation issues. Additionally, an increase in the number of flow paths results in a reduction in valve style modifier, or F_{d}, values, leading to decreased noise levels. Effective mitigation or elimination of cavitation and noise of the present exemplary embodiments of cartridges 50 can be achieved by incorporating a higher number of pressure-reducing stages, thus intermixing of internal jet streams.

The segmented ball valve 10a or rotary control valve 10 utilizes a precisely machined cylindrical bore 42 of the segmented ball 20 to accommodate the interchangeable anti-cavitation and noise cartridge 50. Similar as described for the improved seat 90, the curved plates 52 of cartridge 50 are oriented perpendicular or orthogonal to the flow direction 30 and a flow direction 30a. The offset alignment of the openings 55 between the curved plates 52 effectively induce pressure drops through expansion and contraction cycles. As a result of the offset alignment, the flows 30, 30a contract within the openings 55 and expand in the gaps 57 between the circular curved plates 52. Each curved plate 52 defines both a concave surface 52a and a convex surface 52b, wherein the convex surface 52b is on the opposite side of the concave surface 52a of the curved plate 52. The openings or apertures 55 are defined through each surface 52a and 52b of each of the curved plate 52. Both of the curved plates 52 of the improved seat 90 and the cartridge 50 have a circular concavo-convex shape, and the shape of the plates 52 may also be described as having a meniscus lens or partial spherical shell shape. Each of the curved plates in the FIGS. 26-45 have a circular circumference or perimeter to fit within the cylindrical cartridge body 51 and cylindrical interior surface of the seat body 91. The curvature of the curved plates 52 (and corresponding openings 55) direct and enable the flow 30 through the segmented ball 20 and through the openings 55 of the attenuator cartridge or trim 50 to effectively reduce cavitation. Similar to the attenuator seat 90, in case of absence of the attenuator trim or cartridge 50, the pressure drops in the segmented ball 20. When attenuator trim or cartridge 50 is present, the pressure drops in the attenuator trim or cartridge 50 and pressure drop through segmented ball 20 is negligible.

The disclosed exemplary embodiments of the FIGS. 1-45 are designed for liquid application for reducing/eliminating the cavitation. These exemplary embodiments has the advantage of being able to add more numbers of stages as the required pressure drop increases (which is most common in liquids). The number of stages can be easily adjusted by removing the attenuators 100, 50 or 90 and replacing the attenuator 100, 50, or 90 with another attenuator 100, 50 or 90 having a different number of stages. The exemplary embodiments of attenuators 100, 50, and 90 are replaceable and removable for modification, installation, and repair without damage to the other elements of the valve 10 or segmented ball valve 10a as the attenuators 100, 50, 90 are not permanently fixed or welded to the valve 10 or segmented ball valve 10a. Moreover, the present disclosed exemplary embodiments can also be used for gases when the pressure drop is high and flow requirement is not high. Other conventional designs as used for gaseous applications for reduction in noise can be typically achieved with less or fewer number of stages. Practically, adding more number of plates/stages will be difficult in these conventional products for gaseous applications, considering the higher area/volume required for gas flow. If these conventional products for gaseous applications are used for liquids, it can handle only smaller pressure drops as the number of stages are limited.

While a segmented ball valve 10a has been illustrated as an exemplary embodiment, and any type of rotary control valve 10 may be implement the improvements and features as discussed.

While the exemplary embodiments are described with reference to various implementations and exploitations, it will be understood that these exemplary embodiments are illustrative and that the scope of the inventive subject matter is not limited to them. Many variations, modifications, additions and improvements are possible. The teachings and disclosures of the following are hereby intended to be incorporated by reference in their entireties: US Patent Application No. 18/358,648 entitled “Low Noise and Anti-Cavitation Rotary Control Valve” as filed July 25, 2023; and US Provisional Patent Application No. 63/39,2301 entitled “Low Noise and Anti-Cavitation Rotary Control Valve” as filed July 26, 2022.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A valve seat for a rotary control valve comprising
a valve seat body of the valve seat, wherein the valve seat body has a cylindrical shape defining a bore;
a shoulder defined on an exterior surface of the valve seat;
a first circular curved plate within the valve seat body;
a second circular curved plate within the valve seat body, positioned next to the first circular curved plate;
wherein the first circular curved plate defines a first set of openings within the first circular curved plate;
wherein the second circular curved plate defines a second set of openings within the second circular curved plate;
and where in the first set of openings and the second set of openings are unaligned.

2. The valve seat of claim 1, wherein the first circular curved plate defines a first circular curved plate concave surface and a first circular curved plate convex surface.

3. The valve seat of claim 2, wherein the second circular curved plate is positioned downstream of the first circular curved plate and wherein the first circular curved concave surface is upstream of the first circular curved plate convex surface.

4. The valve seat of claim 2, wherein the first circular curved plate and the second circular curved plate are each orthogonal to a flow of the rotary control valve.

5. The valve seat of claim 4, wherein the flow passes into and through the first circular curved plate and then the second circular curved plate.

6. The valve seat of claim 5, wherein each of the first set of openings and the second set of openings are hexagonal-shaped openings of the same size.

7. The valve seat of claim 6, wherein the valve seat defines a seating surface adjacent to the first circular curved plate concave surface configured to seal against a control element of the rotary control valve.

8. The valve seat of claim 7, further comprising a first gap between the first circular curved plate and the second circular curved plate; and further comprising a second gap between the first circular curved plate concave surface and the control element.

9. A cartridge for reducing noise and cavitation within a segmented ball of a rotary control valve, comprising
a first curved plate within the cartridge;
a second curved plate within the cartridge, wherein the second curved plate is adjacent to the first curved plate;
a first plurality of apertures defined on the first curved plate; and
a second plurality of apertures defined on the second curved plate, wherein the second plurality of apertures are unaligned with the first plurality of apertures.

10. The cartridge of claim 9, wherein the first curved plate and the second curved plate each have a circular perimeter.

11. The cartridge of claim 10, wherein the first curved plate and the second curved plate are each orthogonal to a flow direction of the rotary control valve in a fully open position of the rotary control valve.

12. The cartridge of claim 11, wherein the flow direction passes into and through the first curved plate and then the second curved plate.

13. The cartridge of claim 12, wherein the cartridge defines a cylindrical shape and further comprising a first tab extending from the cylindrical shape at a top of the cartridge and a second tab extending from the cylindrical shape at a bottom of the cartridge.

14. The cartridge of claim 13, wherein each of the first tab and the second tab define a stem opening.

15. A method for obtaining a gradual pressure drop in a rotary control valve, comprising the steps of:
inserting a valve seat into a closely fitting port defined within the rotary control valve; and
wherein the valve seat comprises a first circular curved plate and a second circular curved plate orthogonal to a flow direction of the rotary control valve in a fully opened position;
wherein the first circular curved plate defines a first set of apertures, and the second circular curved plate defines a second set of apertures;
wherein the first set of apertures is offset from the second set of apertures; and
inducing a pressure dropping stage between the first circular curved plate and the second circular curved plate.

16. The method of claim 15, further comprising the steps of expanding a fluid flow and contracting the fluid flow within the pressure dropping stage.

17. The method of claim 16, further comprising the step of preventing a pressure of the fluid flow from dropping below a vapor pressure of the fluid flow.

18. The method of claim 17, further comprising the step of contracting the fluid flow between the first circular curved plate and the second circular curved plate.

19. The method of claim 18, further comprising the step of expanding the fluid flow between the first circular curved plate and the second circular curved plate.

20. A method for obtaining a gradual pressure drop in a rotary control valve, comprising the steps of:
providing a segmented ball;
inserting a cartridge into a closely fitting internal cavity defined within the segmented ball; and
wherein the cartridge comprises a first circular curved plate and a second circular curved plate orthogonal to a flow direction of the rotary control valve in a fully opened position;
wherein the first circular curved plate defines a first set of apertures, and the second circular curved plate defines a second set of apertures;
wherein the first set of apertures is offset from the second set of apertures; and
inducing a pressure dropping stage between the first circular curved plate and the second circular curved plate.

21. The method of claim 20, further comprising the steps of expanding a fluid flow and contracting the fluid flow within the pressure dropping stage.

22. The method of claim 21, further comprising the step of preventing a pressure of the fluid flow from dropping below a vapor pressure of the fluid flow.

23. The method of claim 22, further comprising the step of contracting the fluid flow between the first circular curved plate and the second circular curved plate.

24. The method of claim 22, further comprising the step of expanding the fluid flow between the first circular curved plate and the second circular curved plate.

25. The method of claim 22, further comprising the step of replacing the cartridge without replacing the segmented ball.
